(19) United States
(12) Patent Application Publication
(10) Pub. No.: US 2016/0056703 A1
(43) Pub. Date: Feb. 25, 2016

(54) INFORMATION EXCHANGE VIA FLYBACK TRANSFORMER FOR SECONDARY SIDE CONTROL

(71) Applicant: Infineon Technologies Austria AG, Villach (AT)

(72) Inventors: Gerald Deboy, Klagenfurt (AT); Karl Norling, Villach (AT)

(21) Appl. No.: 14/625,250

(22) Filed: Feb. 18, 2015

Related U.S. Application Data
(60) Provisional application No. 62/041,420, filed on Aug. 25, 2014.

(51) Int. Cl. H02M 1/00; H02M 3/335

(52) U.S. Cl. CPC H02M 1/00; H02M 3/33592; H02M 2001/0009; H02M 2001/0012

(57) ABSTRACT

A power circuit is described that includes a transformer having a primary winding and a secondary winding, a primary side coupled to the primary winding and a secondary side coupled to the secondary winding. The primary side includes a primary element configured to switch-on or switch-off based on a primary voltage or a primary current at the primary side. The secondary side includes a secondary element and a control unit that is isolated from the primary side. The control unit is configured to control the secondary element to transfer secondary side energy, via the transformer, from the secondary side to the primary side to control an amount of primary side energy transferred, via the transformer, from the primary side to the secondary side.

This application claims the benefit of U.S. Provisional Application No. 62/041,420, filed Aug. 25, 2014, the entire content of which is incorporated by reference herein.

### TECHNICAL FIELD

This disclosure relates to power converters, and more particular, techniques for controlling flyback power converters.

### BACKGROUND

A typical flyback converter includes a primary side circuit, a transformer, and a secondary side circuit. The primary side circuit is connected to a power source and includes at least one switching element that controls the amount of energy transferred to the secondary side via the transformer. The transformer serves as an electrically isolated channel to transfer energy from the primary side circuit to the secondary side circuit. The secondary side circuit is coupled to a load to be powered.

In a traditional flyback converter, at least one diode coupled in a current path of a secondary side winding of the transformer is included to block current (e.g., from flowing from the transformer to the secondary side circuit when the primary side transistor is turned on or from flowing from an output capacitor on the secondary side to the secondary side winding and back to the primary side). One disadvantage of using a diode in the secondary side circuit is that, when the primary side switching element is turned off and energy is transferred from the transformer to the secondary side circuit (and the load), energy is lost due to a voltage drop (R_{DS-ON}) over the diode. To improve efficiency, some flyback converters may be configured such that the traditional diode is replaced by, or put in parallel with, an active element (e.g., one or more transistors), which may be referred to as a secondary side switching element. Such a secondary side switching element may be operated to switch in synchronization with switching behavior of the primary side switching element, which may increase efficiency compared to the using a diode as described above. Operation of the secondary side switching element in synchronization with switching behavior of the primary side switching element may be referred to as synchronous rectification. Generally, there are two ways to implement synchronous rectification: the first way is referred to as “control-driven” synchronous rectification, and the second way is known as “self-driven” synchronous rectification.

In a control-driven scheme, the secondary side switching element is driven by gate-drive signals that are derived from the gate-drive signal of the primary side switching element. In other words, the control-driven scheme generally requires information to pass, via one or more additional electrically isolated signal paths or communication links other than the transformer, from the primary side circuit of the flyback to the secondary side circuit of the flyback. Using the information received via the additional electrically isolated signal paths, sent from the primary side, a secondary side controller can determine the state of the gate-drive signals controlling the primary side switching element. Based on the state of the gate-drive signals controlling the primary side switching element, can determine when to cause the secondary side switching element to turn-on or turn-off in synchronization with the primary side switching element. Since a control-driven synchronous rectification control scheme uses an additional, communication link, control-driven synchronous rectification may increase size, cost, and/or complexity of the flyback power converter.

Self-driven synchronous rectification may be more attractive for some flyback applications since self-driven control is simpler and requires fewer components than the control driven scheme. In a self-driven scheme, a secondary side controller may forgo the information about the state of the gate-drive signals controlling the primary side switching element, received from the primary side circuit via the additional, communication link, and instead may simply monitor energy (e.g., a current and/or voltage of energy) being transmitted to the secondary side circuit via the transformer. Based on the monitored energy, the secondary side controller can control the secondary side switching element to switch in-synchronization with the operations of the primary side switching element. Although the reliance on a self-driven synchronous rectification control scheme may decrease size, cost, and/or complexity as compared to a control-driven scheme, self-driven synchronous rectification may sacrifice accuracy and quality of a flyback converter by producing a lower quality and less efficient power output.

### SUMMARY

In general, circuits and techniques are described for enabling a flyback power converter to transfer energy via a transformer (e.g., a transformer that is used to transfer energy from the primary side of the flyback power converter to the secondary side of the flyback converter to power a load) from its secondary side circuit to its primary side circuit, as a way of sending information from the secondary side circuit back to the primary side circuit, without relying on any additional, communication links, other than the transformer. In other words, information (e.g., secondary side voltage levels, secondary side current levels, control signals originating from the secondary side, etc.) can be generated by circuitry on the secondary side of the transformer, communicated as energy transfers through the transformer, and detected and interpreted by circuitry at the primary side as secondary side voltage levels, secondary side current levels, control signals originating from the secondary side, etc. . . . . Since communication occurs by transferring energy using the same transformer that is responsible for transferring primary side energy to the secondary side to power a load, electrical isolation is maintained between the two sides of the flyback power converter without relying on a separate electrically isolated transmission channel linking the two sides. For example, the circuits and techniques may enable a fly back power converter to forgo use of an opto-coupler circuit or other type of additional, electrically isolated transmission channel that other conventional power converters may require to exchange information between the secondary side and the primary side of the transformer.

In one example, the disclosure is directed to a power circuit that includes a transformer, a primary side and a secondary side. The transformer comprises a primary winding and a secondary winding. The primary side is coupled to the primary winding and includes a primary element configured to switch-on or switch-off based on a primary voltage or a primary current at the primary side, and a secondary side coupled to the secondary winding. The secondary side is coupled to the secondary winding and includes a secondary element and a control unit that is isolated from the primary side. The control unit is configured to control the secondary element to transfer secondary side energy, via the transformer, from the secondary side to the primary side to control an amount of primary side energy transferred, via the transformer, from the primary side to the secondary side.

In another example, the disclosure is directed to a power circuit that includes a transformer comprising a primary winding and a secondary winding, a secondary side coupled to the secondary winding, and a primary side coupled to the primary winding. The primary side includes a primary element and primary logic. The primary logic is configured to control the primary element by at least detecting, at the primary side, secondary side energy being transferred from the secondary side, via the transformer, to the primary side.

In another example, the disclosure is directed to a method that includes controlling, by a control unit positioned at a secondary side of a power converter, a secondary element of the secondary side consistent with synchronous rectification. The secondary element is coupled to a secondary winding of a transformer of the power converter. The method further includes controlling, by the control unit, the secondary element to transfer secondary side energy, via the transformer, from the secondary side to a primary side of the power converter to control an amount of primary side energy transferred, via the transformer, from the primary side to the secondary side.

In another example, the disclosure is directed to a method that includes detecting, by control logic positioned at a primary side of a power converter, secondary side energy being transferred from a secondary side of the power converter, via a transformer of the power converter, to the primary side. The method further includes responsive to detecting the secondary side energy, switching on, by the control logic, the primary element.

In another example, the disclosure is directed to a power circuit that includes a transformer comprising a primary winding and a secondary winding, a primary side coupled to the primary winding, and a secondary side coupled to the secondary winding. The primary side includes a primary element configured to switch-on or switch-off based at least in part on a primary voltage or a primary current at the primary side. The secondary side includes a secondary element and secondary logic that is isolated from the primary side. The secondary logic is configured to: detect a change to an amount of load coupled to the power circuit, and in response to detecting the change to the amount of load, control the secondary element to transfer secondary side energy, via the transformer, from the secondary side to the primary side to control an amount of primary side energy transferred, via the transformer, from the primary side to the secondary side.

In another example, the disclosure is directed to a power circuit that includes a transformer comprising a primary winding and a secondary winding, a secondary side coupled to the secondary winding, and a primary side coupled to the primary winding. The primary side includes a primary element and a primary controller configured to control the primary element by at least detecting, at the primary side, secondary side energy being transferred from the secondary side, via the transformer, to the primary side in response to the secondary side detecting a change to an amount of load coupled to the secondary side.

In another example, the disclosure is directed to a method that includes controlling, by a control unit positioned at a secondary side of a power converter, a secondary element of the secondary side consistent with synchronous rectification, wherein the secondary element is coupled to a secondary winding of a transformer of the power converter. The method further includes detecting, by the control unit, a change to an amount of load coupled to the secondary side of the power converter, and responsive to detecting the change to the amount of load, controlling, by the control unit, the secondary element to transfer secondary side energy, via the transformer, from the secondary side to a primary side of the power converter to control an amount of primary side energy transferred, via the transformer, from the primary side to the secondary side.

In another example, the disclosure is directed to a method that includes detecting, by a control unit positioned at a primary side of a power converter, secondary side energy being transferred from a secondary side of the power converter, via a transformer of the power converter, to the primary side in response to a change to an amount of load coupled to the secondary side. The method further includes responsive to detecting the secondary side energy, switching on, by the control unit, the primary element.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example system for converting power from a power source, in accordance with one or more aspects of the present disclosure.

FIG. 2 is a conceptual diagram illustrating an example power converter of the example system shown in FIG. 1.

FIG. 3 is a conceptual diagram illustrating an additional example power converter of the example system shown in FIG. 1.

FIGS. 4A and 4B are flowcharts illustrating example operations of a primary side of either of the example power converters, in accordance with one or more aspects of the present disclosure.

FIGS. 5A-5C are flowcharts illustrating example operations of a secondary side of either of the example power converters, in accordance with one or more aspects of the present disclosure.

FIGS. 6-11 are a timing diagrams illustrating voltage and current characteristics of either of the example power converters, while performing the operations of FIGS. 4A, 4B, and 5A-5C, in accordance with one or more aspects of the present disclosure.

FIG. 12 is a conceptual diagram illustrating a more detailed view of the primary side of the additional example power converter shown in FIG. 3.

FIG. 13 is a conceptual diagram illustrating a more detailed view of the secondary side of the additional example power converter shown in FIG. 3.

FIGS. 14A and 14B are diagrams illustrating characteristics, as a function of voltage, associated with either of the example power converters having a Gallium Nitride (GaN) based switch device as a primary element as opposed to a silicon based power MOSFET, in accordance with one or more aspects of the present disclosure.

FIG. 15 is a conceptual diagram illustrating an additional example of a power converter that may be used in the example system shown in FIG. 1, in accordance with one or more aspects of the present disclosure.

FIG. 16 is a conceptual diagram illustrating an additional example of a power converter that may be used in the example system shown in FIG. 1, in accordance with one or more aspects of the present disclosure.

FIG. 17 is a flowchart illustrating example operations of the example power converter shown in FIG. 16, in accordance with one or more aspects of the present disclosure.

FIG. 18 is a timing diagram illustrating voltage and current characteristics of the example power converter shown in FIG. 16.

FIG. 19 is a conceptual diagram illustrating an example of a conventional power converter that relies on a separate electrically isolated transmission channel linking the primary and secondary sides of the conventional power converter.

### DETAILED DESCRIPTION

A typical flyback converter includes a primary side circuit, a transformer, and a secondary side circuit. The primary side circuit is connected to a power source such as a power grid, battery, or other source of power, and includes at least one switching element that controls the amount of energy transferred to the secondary side via the transformer. The transformer serves as an electrically isolated channel to transfer energy from the primary side circuit to the secondary side circuit. The secondary side circuit is coupled to a load to be powered, in some cases via an output capacitor.

The primary side circuit further includes a driver circuit that drives the primary side switching element. The driver circuit switches the primary side switching element on and off in order to transfer energy from the power source to the secondary side circuit via the transformer. In operation, the driver circuit may turn on the primary side switching element to transfer energy to the transformer. This energy may be stored as a magnetic flux in an air gap of the transformer, between primary and secondary windings of the transformer. The driver circuit may then turn off the primary side switching element, which may cause the energy stored in the transformer to be transferred to the secondary side circuit and the load.

Some systems may require a flyback converter to achieve a certain level of efficiency. To aid in efficiency, a traditional flyback converter includes a primary side controller, and at least one diode coupled in a current path of a secondary side winding of the transformer. Such a diode may be used to block current from flowing from the transformer to the secondary side circuit when the primary side transistor is turned on by the driver circuit, so that energy is stored in the transformer. Furthermore the diode prevents current flow from the output capacitor on the secondary side to the secondary side winding and back to the primary side.

One disadvantage of using a diode in the secondary side circuit such as described above is that, when the primary side switching element is turned off and energy is transferred from the transformer to the secondary side circuit (and the load), energy is lost due to a voltage drop (Rds-on) over the diode. In some examples, a flyback converter may be designed to include a diode with a reduced voltage drop which may improve efficiency compared to a diode with a higher voltage drop; however energy may still be lost, which may be undesirable in some applications. To further improve efficiency, some flyback converters may be configured such that the traditional diode is replaced by, or put in parallel with, an active element (e.g., one or more transistors), which may be referred to as a secondary side switching element. Such a secondary side switching element may be operated to switch in synchronization with switching behavior of the primary side switching element, which may increase efficiency compared to the using a diode as described above. For example, a secondary side switching element may be operated to turn off when the primary side switching element is turned on, so that it acts as an open circuit and blocks energy (i.e., current) from exiting the transformer while energy is being transferred to the transformer. The secondary side switching element may also be turned on when the primary side switching element is turned off, so that it acts as a short circuit and allows energy to be transferred from the transformer to the secondary side circuit and the load, without a voltage drop that causes energy loss or with a small voltage drop that causes relatively little energy loss. Operation of the secondary side switching element in synchronization with switching behavior of the primary side switching element as described above may be referred to as synchronous rectification.

Typically, there are two ways to implement synchronous rectification: the first way is referred to as “control-driven” synchronous rectification, and the second way is known as “self-driven” synchronous rectification. In a control-driven scheme, the secondary side switching element is driven by gate-drive signals that are derived from the gate-drive signal of the primary side switching element. In other words, the control-driven scheme generally requires information to pass from the primary side circuit of the flyback to the secondary side circuit of the flyback, via one or more additional electrically isolated signal paths other than the transformer. Using the information from the primary side, a secondary side controller can determine, based on the gate-drive signals controlling the primary side switching element, when to cause the secondary side switching element to turn-on or turn-off in synchronization with the primary side switching element. Whereas, in a self-driven scheme, a secondary side controller may monitor energy (e.g., a current and/or voltage of energy) transmitted to the secondary side via the transformer and control the secondary side switching element to switch in synchronization with operation of the primary side switching element.

Self-driven synchronous rectification may be more attractive for some flyback applications since self-driven control requires fewer components than the control driven scheme. However, the performance of self-driven synchronous rectification depends on the accuracy of switching (e.g., how soon the secondary side switching switches-on, immediately after the primary element switches off, and how soon before the primary element switches-on, does the secondary side switching element switch-off), and may be less efficient than a control-driven scheme.

As described above, in a self-driven scheme, a secondary side controller may monitor energy (e.g., a current and/or voltage of energy) transmitted to the secondary side via the transformer and control the secondary side switching element to switch in synchronization with operation of the primary side switching element. According to these examples, a secondary side controller in a self-driven scheme may determine when to turn off based on monitoring a current, or a rate of change associated with the current, of the secondary side (e.g., a current through the secondary side winding of the transformer, output capacitor, load, or other representative current). For example, according to a typical synchronous rectification flyback converter, when the primary side switching element is off, a secondary side controller turns off the secondary side switching element when the monitored current has reached a value of substantially zero amps. According to these typical examples, turning off the secondary side switch when the secondary side current reaches zero amps ensures that the secondary side switching element is off when the primary side switching element is turned on.

Some systems may require a flyback converter to be able to maintain an output voltage within a specific tolerance window. For example, in case of a load jump (e.g., connecting or “plugging” a load to the output of the flyback converter) the system may require the flyback converter to not violate the output voltage thresholds even with a sudden change in the amount of load connected to the output. And some systems may require a flyback converter use a very low amount of power when not powering a load. For example, some industry or government regulations (e.g., EnergyStar®, etc.) may require systems to operate flyback converters using a very low amount of power while operating in “stand-by” mode and/or in no-load or very “light” load conditions. In order to successfully maintain the output voltage in a tight regulation window, even during load jumps and/or no load conditions, a typical flyback converter may rely on an auxiliary winding on the primary side of the transformer to detect the current output voltage and/or an additional, electrically isolated channel to transfer a signal from the secondary side circuit to the primary side circuit, to indicate when a load jump is occurring.

For example, to determine whether a load suddenly requires the flyback converter to provide power, a feedback signal may automatically be provided from the secondary side to the primary side via an additional, electrically isolated channel to indicate whenever a load jump is occurring. Typically, the additional, electrically isolated channel is achieved by using an opto-coupler and some additional feedback circuitry on the secondary side. However, it may be desirable to avoid the use of Opto-couplers or other specific communication elements for some types of applications. For example, opto-couplers or other components that provide an additional, electrically isolated channel can be cost prohibitive for some applications.

In other examples, to determine whether a load suddenly requires the flyback converter to provide power, the primary controller may momentarily “switch-on” to measure the output voltage. By switching-on, the primary controller may cause a small amount of energy to transfer via the transformer to the secondary side. The small energy transfer may induce a “reflective voltage” at an auxiliary winding of the transformer that the primary controller can use to determine whether a load is connected to the output. This measurement requires the flyback converter perform at least one switching cycle on the primary side to allow measurement of the reflected voltage during the phase where the energy is transferred from the transformer to the secondary side. Typically the flyback converter is operated in burst mode to allow these measurements. Burst mode operation mandates however relatively short intervals between bursts to be sure (e.g., in case of a load jump) the output voltage stays within its voltage limits. Relatively high amount of burst mode activity may cause the flyback converter to use more energy and conflict with the requirements of the system to use little or no power during no-load and light load conditions.

This disclosure is directed to circuits and techniques that enable a flyback converter be controlled based on signals received by the primary side circuit from the secondary side circuit via the same transformer that the flyback converter uses to transfer energy from the primary side circuit to the secondary side circuit to power a load. The signals received from the secondary side may serve a variety of purposes to aid in the control of the flyback converter. In some examples, the signals received from the secondary side may enable the flyback converter to more accurately control a secondary side synchronous rectification element, determine the output voltage level, and/or determine a load condition, all without using additional, electrically isolated channels or unnecessarily pulsing or operating in burst mode so as to induce a reflective voltage at an auxiliary winding.

According to the circuits and techniques of this disclosure, a controller located in the primary side circuit is configured to monitor energy transferred, via the transformer, from the secondary side circuit to the primary side circuit. The primary side controller is configured to control operation of the primary side switching element based on the monitored energy transferred from the secondary side circuit. The transformer that is used to transfer energy from the secondary side to the primary side is the same transformer that is used to transfer energy from the power source coupled to the primary side circuit to the load coupled to the secondary side circuit.

For example, the primary side controller may be configured to monitor or “sense” one or more of a voltage across a primary side winding of the transformer, a current through the primary side winding of the transformer, and a voltage across the primary side switching element (e.g., a drain-source voltage of the primary side switching element). When the primary side controller identifies a change in the energy transferred from the secondary side circuit to the primary side circuit via the transformer (i.e., based on one or more of the voltages and/or currents that may be monitored as described above), the primary side controller may cause the primary side switching element to change conduction state (switch on or off).

As one specific example, the primary side controller may be configured to monitor whether a voltage associated with the primary side switching element (i.e., a drain-source voltage) has fallen below a threshold that indicates that energy is transferred from the secondary side circuit to the primary side circuit (e.g., a threshold of zero volts or some other value depending on how the circuit is configured), and control the primary side switching element to switch (e.g., turn on) in response to detecting the negative voltage. According to this example, the primary side controller may be configured to turn the primary side switching element off based on one or more of: a time elapsed since the primary side switching element was turned on (e.g., based on a counter or clock), or monitoring a current through the primary side winding of the transformer.

In this manner, the secondary side circuit may signal information (e.g., to control switching of the primary side switching element) to the primary side circuit in order to control an amount of energy transferred from the primary side circuit to the secondary side circuit (e.g., to control switching operation of the primary side switching element), without an electrically isolated signal path (i.e., an opto-coupler, additional transformer, Gigantic Magnetoresistance (GMR) element, or the like) in addition to the transformer. Therefore, the primary side switching elements may be controlled with greater accuracy, lower cost, and lower complexity compared to other techniques described above. The information transmitted in this way from the secondary side may serve a variety of purposes to aid in the control of the flyback converter (e.g., to more accurately control a secondary side synchronous rectification element, to determine the output voltage level, to determine a load condition, and the like).

In order to signal information to the primary side circuit, a secondary side controller according to the circuits and techniques described herein may be configured to operate the secondary side switching element differently than according to typical synchronous rectification as described above, in order to cause energy to be transmitted from the secondary side circuit to the primary side circuit in a manner that can be identified by the primary side controller. As set forth above, a typical secondary side switching element may be controlled in synchronization with switching of a primary side switching element, such that the secondary element and the primary element are not in the same state (on or off) at the same time. For a typical synchronous rectification flyback converter, as also set forth above, the secondary side controller turns off the secondary side switching element when a current associated with the secondary side reaches substantially zero, in order to ensure that both the primary and secondary side switching elements are not on at the same time.

According to the circuits and techniques described herein, in contrast to a typical synchronous rectification flyback converter as described above that always switches the secondary side switching element off when the secondary side current reaches zero (e.g., while operating in discontinuous or critical conduction mode), or when a change in the secondary side current satisfies a change threshold or other signal, or when the primary side gate signals are otherwise derived from a voltage or current at the secondary side, the flyback converter described herein may in some cases not cause the secondary side switching element to turn off whenever either of the aforementioned conditions is true. By not switching off the secondary side switching element under one of the conditions during which the secondary side switching element would normally be switched-off, the flyback converter according to the circuits and techniques can intentionally cause energy to be transferred from the secondary side to the primary side. In other words, by sending a control signal from the secondary side, via the transformer, to the primary side, the flyback can cause energy to be sent from the secondary side that is detected by the primary side controller and used by the primary side controller to initiate switching operation of the primary side as described above.

This disclosure describes various techniques for controlling a secondary side switching element (i.e., a synchronous rectification switching element) to cause energy to be transferred across the transformer in a manner that may be interpreted by the primary side circuit. For example, the secondary side switching element may be turned off and held off, when the monitored secondary side current reaches zero and the voltage at the output of the flyback converter satisfies a voltage threshold. For example, if the voltage at the output of the flyback converter is at a sufficient voltage required by a load (e.g., greater than or equal to a voltage threshold) when the monitored secondary side current reaches zero, a secondary side controller will switch off the secondary side switching element.

In some examples, according to the circuits and techniques described herein, the secondary side switching element may be switched back on after being switched off and the voltage at the output of the flyback converter has fallen below a voltage threshold. For example, if after the secondary side switching element is turned off, the secondary side controller later determines that the voltage at the output of the flyback converter has fallen at or below a voltage required by the load (e.g., less than or equal to the voltage threshold), the secondary side controller will switch on the secondary side switching element back on for enough time (i.e., a predefined time interval) to cause energy to be transferred from the secondary side circuit to the primary side circuit (e.g., to signal to the primary side the need by the secondary side for more energy to increase the voltage at the output).

In some examples, according to the circuits and techniques described herein, the secondary side switching element may be held on and not switched off when the monitored secondary side current reaches zero if, when the secondary side current reaches zero, the voltage at the output of the flyback converter does not satisfy the voltage threshold (e.g., less than or equal to the voltage threshold). For example, after the secondary side current reaches zero, and before the primary element switches on, the secondary side controller may wait some time (i.e., a predefined time interval) after the monitored secondary side current reaches zero, to turn off the secondary side switching element. The additional time that the secondary side switching element waits to turn off while the secondary side current is less than or equal to a low current threshold (e.g., zero amps) will cause energy to be transferred from the secondary side circuit to the primary side circuit (e.g., to signal to the primary side the need by the secondary side for more energy to increase the voltage at the output).

In this manner, the flyback converter can configure the secondary side circuit to transfer energy from the secondary side, through the transformer, and to the primary side. In this way, the flyback converter can communicate control information from the secondary side circuit to the primary side circuit, using a secondary side switching element and a transformer, and without relying on an additional, electrically isolated communication link normally used by other flyback converters to transfer information between the primary side circuit and the secondary side circuit.

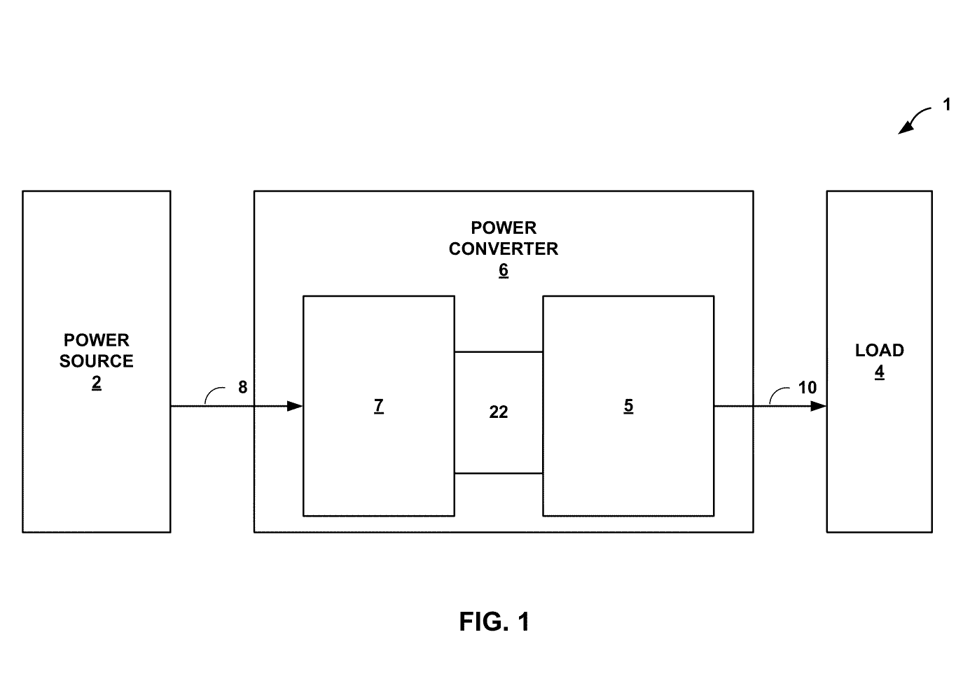

FIG. 1 is a conceptual diagram illustrating system 1 for converting power from power source 2, in accordance with one or more aspects of the present disclosure. FIG. 1 shows system 1 as having four separate and distinct components shown as power source 2, power converter 6, and load 4, however system 1 may include additional or fewer components. For instance, power source 2, power converter 6, and load 4 may be four individual components or may represent a combination of one or more components that provide the functionality of system 1 as described herein.

System 1 includes power source 2 which provides electrical power to system 1. Numerous examples of power source 2 exist and may include, but are not limited to, power grids, generators, transformers, batteries, solar panels, windmills, regenerative braking systems, hydro-electrical or wind-powered generators, or any other form of devices that are capable of providing electrical power to system 1.

System 1 includes power converter 6 which operates as a flyback converter that converts one form of electrical power provided by power source 2 into a different, and usable form, of electrical power for powering load 4. Power converter 6 is shown having primary side 7 separated by transformer 22 from secondary side 5. In some examples, transformer 22 may include more than one transformer or sets of transformer windings configured to transfer energy from source 2 to load 4. Using transformer 22 and the components of primary side 7 and secondary side 5, power converter 6 can convert the power input at link 8 into a power output at link 10.

Load 4 (also sometimes referred to herein as device 4) receives the electrical power converted by power converter 6. In some examples, load 4 may use electrical power from power converter 6 to perform a function.

Power source 2 may provide electrical power with a first voltage level and current level over link 8. Load 4 may receive electrical power that has a second voltage and current level, converted by power converter 6 over link 10. Links 8 and 10 represent any medium capable of conducting electrical power from one location to another. Examples of links 8 and 10 include, but are not limited to, physical and/or wireless electrical transmission mediums such as electrical wires, electrical traces, conductive gas tubes, twisted wire pairs, and the like. Each of links 8 and 10 provide electrical coupling between, respectively, power source 2 and power converter 6, and power converter 6 and load 4.

In the example of system 1, electrical power delivered by power source 2 can be converted by converter 6 to power that has a regulated voltage and/or current level that meets the power requirements of load 4. For instance, power source 2 may output, and power converter 6 may receive, power which has a first voltage level at link 8. Power converter 6 may convert the power which has the first voltage level to power which has a second voltage level that is required by load 4. Power converter 6 may output the power that has the second voltage level at link 10. Load 4 may receive the converted power that has the second voltage level at link 10 and load 4 may use the converted power having the second voltage level to perform a function (e.g., power a microprocessor, charge a battery, etc.).

In operation, as described in more detail below with respect to the additional figures, power converter 6 may control the level of current and voltage at link 10 by exchanging information between secondary side 5 and primary side 7, via transformer 22. As described herein, converter 6 is configured to pass information, from secondary side 5, via transformer 22, to primary side 7. In other words, rather than include an additional, electrically isolated communication link normally used by other flyback converters to transfer information between two sides of a flyback, converter 6 is configured to transfer energy, via transformer 22, as a way to send information from secondary side 5 to primary side 7, for example, to communicate to primary side 7, that load 4 requires additional energy from source 2.

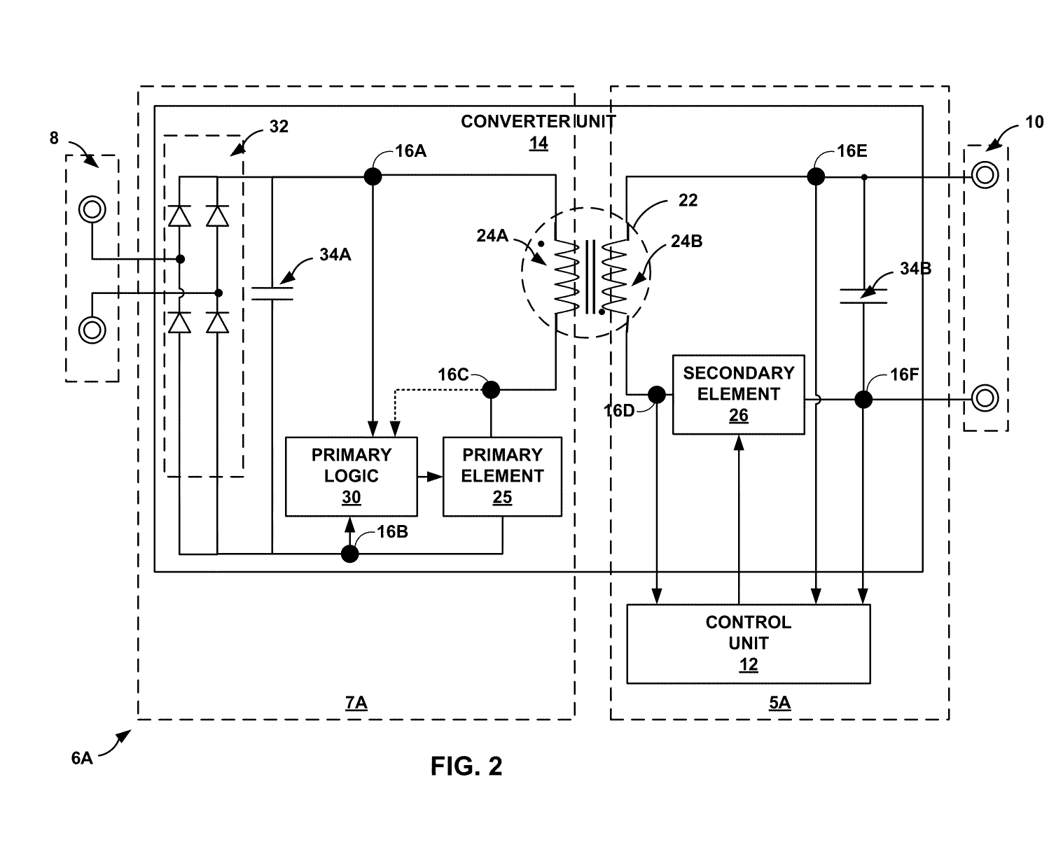

FIG. 2 is a conceptual diagram illustrating power converter 6A as one example of power converter 6 of system 1 shown in FIG. 1. For instance, power converter 6A of FIG. 2 represents a more detailed exemplary view of power converter 6 of system 1 from FIG. 1 and the electrical connections to power source 2 and load 4 provided by links 8 and 10 respectively.

Power converter 6A may include two electrical components, e.g., control unit 12 and converter unit 14, that power converter 6A uses to convert electrical power received via link 8 and outputs at link 10. Power converter 6A may include more or fewer electrical components. For instance, in some examples, control unit 12 and converter unit 14 are a single electrical component or circuit while in other examples, more than two components and/or circuits provide power converter 6A with the functionality of control unit 12 and converter unit 14. In some examples, control unit 12 is contained within power converter 6A and in some examples, control unit 12 represents an external component associated with power converter 6A. In any event, whether an internal component or an external component, control unit 12 may communicate with converter unit 14 to cause power converter 6A to perform the techniques described herein for convening power from supply 2 and outputting the converter power to load 4.

Converter unit 14 may be referred to as a flyback converter and is described in more detail below. In general, converter unit 14 includes transformer 22 for providing electrically isolated energy transfers between an input port coupled to link 8 and one or output ports coupled to link 10. Transformer 22 has primary side windings 24A and secondary side windings 24B. Although shown with only two windings 24A and 24B, transformer 22 may have additional windings or sets of windings. For example, transformer 22 may have an auxiliary winding on primary side 7A or secondary side 5A supply a voltage or current to primary logic 30 or control unit 12.

Converter unit 14 is bifurcated into two regions, primary side 7A and secondary side 5A. The portion of converter unit 14 that is coupled to primary side windings 24A (e.g., full-bridge rectifier 32, decoupling capacitor 34A, primary logic 30, primary element 25, nodes 16A-16C, etc.) makes up primary side 7A of converter unit 14. The portion of converter unit 14 that is coupled to secondary side windings 24B (e.g., secondary element 26, output capacitor 34B, nodes 16D-16F, etc.) makes up secondary side 5A of converter unit 14.

Converter unit 14 includes transformer 22, primary element 25, secondary element 26, primary logic 30, capacitors 34A and 34B, and rectifier 32. Primary element 25 and secondary element 26 each represent any suitable combination of one or more discrete power switches, metal-oxide-semiconductor field-effect transistor (MOSFET)s, lateral power transistors, Gallium Nitride (GaN) high-electron-mobility transistor (HEMT), lateral insulated-gate bipolar transistor (IGBT), other types of transistors, or other switching elements for use in a flyback converter. For example, primary element 25 and secondary element 26 may each be Gallium Nitride (GaN) or Silicon Carbide based power HEMTs. In some examples, primary element 25 and secondary element 26 may each be transistor based switching devices based on wide band gap materials (e.g., GaN HEMTs, SiC MOSFETs or JFETs, etc. Converter unit 14 may include additional switches, capacitors, resistors, diodes, transformers, and/or other electrical components, elements, or circuits that are arranged within converter unit 14 to provide an output voltage at link 10 based on an input voltage at link 8.

In some examples, elements 25 and/or 26 may each represent a single discrete switch (e.g., a high voltage planar MOSFET, a vertical device, such as a Superjunction device, a lateral power transistor, a GaN HEMT, lateral IGBT, etc.). In some examples, elements 25 and/or 26 may each be a system-in-package (SIP) switching element that includes a discrete switch and a driver contained within a single package or an integrated circuit comprising power switches and driver (sometimes referred to as a System on Chip or simply “SoC”) on a single chip. In some examples, elements 25 and/or 26 may be each a GaN based switch in combination with an additional IC that includes a start-up cell, a gate driver, current and/or voltage sense circuitry, etc. Such an IC could be a monolithic integrated circuit and/or could be manufactured using a high-voltage power IC (HV Power IC) process and technique, or other suitable manufacturing processes and techniques.

Control unit 12 of power converter 6A may provide command and control signals to converter unit 14 to control at what time and in what form or magnitude of output voltage that converter unit 14 provides at link 10. Control unit 12 may generate driver signals for controlling secondary element 26, based on voltage and/or current levels detected at link 10 and one or more of nodes 16D-16F of secondary side 5A of converter unit 14. In other words, control unit 12 may control secondary element 26 based on the voltage and current levels detected at various parts of secondary side 5A of converter unit 14.

Control unit 12 can comprise any suitable arrangement of hardware, software, firmware, or any combination thereof, to perform the techniques attributed to control unit 12 herein. For example, control unit 12 may include any one or more microprocessors, digital signal processors (DSPs), application specific integrated circuits (ASICs), field programmable gate arrays (FPGAs), or any other equivalent integrated or discrete logic circuitry, as well as any combinations of such components. When control unit 12 includes software or firmware, control unit 12 further includes any necessary hardware for storing and executing the software or firmware, such as one or more processors or processing units. In general, a processing unit may include one or more microprocessors. DSPs, ASICs, FPGAs, or any other equivalent integrated or discrete logic circuitry, as well as any combinations of such components. Although not shown in FIG. 2, control unit 12 may include a memory configured to store data. The memory may include any volatile or non-volatile media, such as a random access memory (RAM), read only memory (ROM), non-volatile RAM (NVRAM), electrically erasable programmable ROM (EEPROM), flash memory, and the like. In some examples, the memory may be external to control unit 12 and/or power converter 6A, e.g., may be external to a package in which control unit 12 and/or power converter 6A is housed.

Primary logic 30 represents a logic block for controlling primary element 25 by at least detecting energy transfers from secondary side 7 and controlling primary element 25 in response to the detected energy transfers. Primary logic 30 may enable or disable primary element 25 based on a voltage or current detected at primary element 25 and/or nodes 16A-16C which may change as a result of energy being transferred from output capacitor 34B, via transformer 22, to primary side 7A.

Primary logic 30 may include one or more state machines, discrete elements, drivers, or other analog and/or digital logic for sensing a voltage and/or current at any of nodes 16A-16C and causing primary element 25 to switch-on or switch-off based on the sensed voltage and/or currents. For example, secondary side 5A of converter unit 14 may transfer energy through transformer 22 and to primary side 7A of converter unit 14 resulting in a voltage and/or current change at primary side 7A which results in a detectable change at primary element 25. Primary logic 30 may sense the voltage and/or current change at nodes 16A-16C, and the voltage and/or current change may cause primary logic 30 to drive primary element 25 into a switched-on or switched-off state.

As used throughout this disclosure, when referring to a switching element (e.g., a power switch. MOSFET. IGBT, etc.), the terms “close”, “enable”, “switch-on”. “turn-on” and the like are used to describe when a switching element transitions from operating in a first state in which the switching element does not conduct in a forward direction, for example a forward direction across the drain and source terminals of a MOSFET) or otherwise blocks current to operating in a second state in which the switching element does conduct and does not block current in the forward direction. Conversely, as used throughout this disclosure, when referring to a switching element, the terms “open”, “disable”, “switch-off”, “turn-off”, and the like are used to describe when a switching element transitions from operating in a second state in which the switching element does conduct and does not block current to operating in a first state in which the switching element does not conduct or otherwise blocks current.

The term “cycle” is used throughout the disclosure to refer to instances in which a switching element transitions from operating in a first operating state, to operating in a second operating state, and to operating again, back in the first operating state. For example, a switching element may begin by operating in a switched-on state. The switching element may cycle by switching-off after operating in the switched-on state, and then switch back on to complete the cycle. Conversely, a switching element may start by operating in a switched-off state. The switching element may cycle by switching-on after operating in the switched-off state, and then switch back off to complete the cycle.

In accordance with techniques and circuits of this disclosure, power converter 6A may convert or adapt power received from supply 2 and provide the converted or adapted power to load 4. Power converter 6A may receive a voltage or draw a current at link 8 and convert the voltage or current at link 8 into a suitable voltage or current at link 10 for powering load 4.

Control unit 12 may control power converter 6A from secondary side 5A by transferring energy from secondary side 5A, via transformer 22, to primary side 7A, as a way to control primary element 25, in order to convert the power received from supply 2 into a suitable form of power used by load 4. In other words, despite being isolated from primary side 7A, control unit 12 may be configured to control power converter 6A from secondary side 5A, for example, to initiate control of power converter 6A from secondary side 5A.

Control unit 12 may control secondary element 26 to perform at least two functions. The first function of secondary element 26 is to perform synchronous rectification. The second function performed with control unit 12 using secondary element 26 is for transferring energy, as a way to exchange information, from secondary side 5A to primary side 7A. The types of information being exchanged from secondary side 5A may serve any of a variety of purposes, in order to aid in the control of power converter 6A. For example, in some cases, power converter 6A may rely on the information from secondary side 5A to more accurately control a secondary side synchronous rectification element located at secondary side 5A. In some examples, power converter 6A may rely on the information from secondary side 5A to determine the output voltage level at link 10 to determine whether to cause more energy to be transferred from primary side 7A to secondary side 5A. Furthermore, in some examples, power converter 6A may rely on the information from secondary side 5A to determine a load condition at link 10, for instance, to exit from a “stand-by mode” during which power converter 6A consumes a minimal amount of power to an operational mode during which power converter 6A provides power to load 4.

For example, to perform synchronous rectification, from secondary side 5A, control unit 12 may determine the operating state of primary element 25 based on the voltage and/or current at secondary side winding 24B. Control unit 12 may cause secondary element 26 to operate in synch, and change operating states depending on the state of primary element 25. Control unit 12 may detect when primary element 25 switches-off based on the voltage at secondary winding 24B, and in response, cause secondary element 26 to switch-on. Control unit 12 may determine, based on the current at secondary side winding 24B, when to cause secondary element 26 to switch-off, before primary element 25 switches back-on, such that the conduction periods of secondary element 26 and primary element 25 do not overlap.

In other words, control unit 12 may initiate the turn-on of primary element 25. The time at which primary logic 30 detects a voltage at primary element 25 that falls at or below a voltage threshold may vary depending on the voltage across primary element 25 when the secondary side energy is received a primary side 7A (e.g., the voltage across primary element 25 may be higher or lower when secondary side energy is received due to voltage oscillations where the voltage at primary element 25 oscillates between 250V and 550V). Therefore, the amount of time from when secondary element 26 is switched off to transfer secondary side energy to primary side 7A, and when primary element 25 is switched-on may vary. Hence the moment in time when secondary element 26 switches off may vary from one switching cycle to another even though the primary side duty cycle may be mostly constant. In some examples, the product of input voltage and duty cycle may be constant while the duty cycle alone may vary. Hence, control unit 12 may control when primary element 25 switches on based on the current level at secondary side 5A.

For example, after causing secondary element 26 to switch on, control unit 12 may monitor the current at secondary side 5A to determine when the secondary side current reaches a low current threshold (e.g., zero amps). Responsive to determining that the secondary side current is less than or equal to the low current threshold (e.g., zero amps), control unit 12 may cause secondary element 26 to switch off. In this way, control unit 12 causes secondary element 26 to switch off before primary element 25 switches back on.

As a second function, control unit 12 may control secondary element 26 to transfer energy, as a way to exchange information, from secondary side 5A to primary side 7A. Control unit 12 may perform the second function with secondary element 26 in one of two ways as described in further detail below. In either way, control unit 12 monitors the output voltage (e.g., the voltage at output capacitor 34B) to determine how to control secondary element 26.

Control unit 12 may transfer energy in the first way, if secondary element 26 is already switched on. For example, while control unit 12 operates secondary element 26 in a way that is consistent with synchronous rectification, secondary element 26 may be switched on (e.g., before control unit 12 causes secondary element 26 to switch off in response to detecting a zero level current at secondary side 5A). While secondary element 26 is switched on, control unit 12 monitors the output voltage (e.g., the voltage across output capacitor 34B) to determine whether secondary winding 24B or output capacitor 34B is running low on energy. For example, if the output voltage is less than a voltage threshold required by load 4, control unit 12 determines that more energy is needed from primary side 7A. After determining more energy is needed from primary side 7A, and in response to determining that the secondary side current is at a low current threshold (e.g., zero amps), rather than cause secondary element 26 to switch off consistent with a normal synchronous rectification control scheme, control unit 12 causes secondary element 26 to remain switched on for a pre-determined amount of time, after the secondary side current drops below the low current threshold (e.g., zero amps). Keeping secondary element 26 switched on for a predetermined amount of time after the secondary side current goes below zero will cause energy to transfer from secondary side 5A to primary side 7A. Primary logic 30 may detect the energy transfer as a change in the voltage level at primary side 7A, and in response, immediately initiate a switching operation with primary element 25.

Control unit 12 may transfer energy in the second way, if secondary element 26 is already switched off (e.g., after control unit 12 causes secondary element 26 to switch off in response to detecting a zero level current at secondary side 5A but before primary element 25 switches on during a subsequent switching cycle). While secondary element 26 is switched off, control unit 12 monitors the output voltage (e.g., the voltage across output capacitor 34B) to determine whether secondary winding 24B or output capacitor 34B is running low on energy. If the output voltage is less than a voltage threshold required by load 4, control unit 12 determines that more energy is needed from primary side 7A. After determining more energy is needed from primary side 7A, and rather than cause secondary element 26 to remain switched off (e.g., since the secondary side current is less than or equal to the low current threshold (e.g., zero amps) as control unit 12 would in a normal synchronous rectification scheme) control unit 12 causes secondary element 26 to switch on briefly (e.g., for a pre-determined amount of time) and then switch back off. Cycling secondary element 26 on and off for a predetermined amount of time while the secondary side current is at below a low current threshold (e.g., zero amps) will cause energy to transfer from secondary side 5A to primary side 7A. Primary logic 30 may detect the energy transfer as a change in the voltage level at primary side 7A, and in response, immediately initiate a switching operation with primary element 25.

In this way, rather than turn off secondary element 26 merely in response to the secondary side current reaching less than or equal to a low current threshold (e.g., zero amps) as is the case in other flyback converters, control unit 12 may hold secondary element 26 switched on or cycle secondary element 26 on and off, while the secondary current is less than or equal to a low current threshold (e.g., zero amps), in order to cause information to be sent, as an energy transfer via transformer 22, from secondary side 5A, to primary side 7A. When detected by primary logic 30 at primary side 7A, the information being transferred may represent a signal for initiating power conversion operations (e.g., during a start-up cycle) and/or inducing, from secondary side 5A, a switching operation associated with primary element 25 (e.g., a zero voltage switching operation).

Primary logic 30 may control primary element 25 by at least detecting transfers of energy via transformer 22, from secondary side 5A. Primary logic 30 may recognize an energy transfer from secondary side 5A by detecting a change to the voltage and/or current level at nodes 16A-16C.

For instance, primary logic 30 may include one or more voltage or current sense elements (e.g., a differential amplifier or other type of comparator, a sense resistor or sense FET or other current sensing element) coupled to nodes 16A, 16B and 16C which are configured to detect the voltage and/or current across primary element 25 and at nodes 16A, 16B and 16C. Primary logic 30 may compare the sensed voltage and/or current levels at nodes 16A-16C to one or more voltage or current thresholds. If, for example, a voltage across primary element 25 between nodes 16C and 16B falls below a given voltage threshold used to initiate operations (e.g., in response to the cycling on and off of secondary element 26 when the energy at secondary side 5A is low), primary logic 30 may cause primary element to switch “on” or begin conducting current. If, after switching primary element 25 on, the current through primary element 25 (e.g., at node 16C or 16B) exceeds a given current threshold (e.g., as an indication that sufficient energy has been transferred from primary side 7A), primary logic 30 may cause primary element 25 to “switch-off” or otherwise refrain from conducting current.

Accordingly, primary logic 30 may be configured to operate primary element 25 using a “fixed duty cycle” by turning primary element 25 on when primary logic 30 detects a sufficient drop in voltage at primary element 25 and until the current exceeds a maximum current threshold indicative of a sufficient amount of energy being stored at transformer 22 for that cycle. In other operation modes (e.g. at light load condition) another fixed duty cycle with however a smaller on-time may be utilized. This however does not mean, the primary logic 30 necessarily causes primary element 25 to switch on and off in a fixed switching frequency. Said differently, only the turn-on time of primary element 25 may remain constant between duty cycles while the turn-off time may vary. For example, as the input voltage at primary side 7A varies, then the primary current at the end of a duty cycle may also vary and correspondingly the time required to reach zero current at secondary side 5A may vary. Hence the turn-off period of primary side switching element 25 may vary.

In this way, control unit 12 enables secondary element 26 to have a dual role or purpose, beyond its conventional purpose as a synchronous rectification switching element. Not only can control unit 12 cause secondary element 26 to switch on after primary element 25 switches off consistent with synchronous rectification, control unit 12 can hold secondary element 26 switched on, or cycle secondary element 26 on and off, when the secondary side current is less than or equal to zero volts while primary element 25 is switched-off, to cause energy to be transferred from secondary side 5A to primary side 7A across transformer 22 that is interpreted at primary logic 30 as a command being sent from control unit 12 to initiate a switching operation of primary element 25.

In some examples, control unit 12 may be configured to vary, from secondary side 5A, the amount of power converted from primary side 7A to secondary side 5A, per unit of time. For example, control unit 12 may determine whether to leave secondary element 26 switched-on for an amount of time after the secondary side current drops to or below zero amps. By varying the amount of time that control unit 12 causes secondary element 26 to remain switched-on, control unit 12 effects the quantity of switching cycles of primary element 25, per unit of time.

In some example, primary element 25 may be switched-on and off at a high switching frequency (e.g., greater than or equal to one MHz) at the same time that the switching frequency associated with secondary element 26 (e.g., the frequency with which secondary element 26 is switched-on and off) is low (e.g., less than or equal to one MHz). In some examples, primary logic 30 may cause primary element 25 to turn-off according to a current level detected through primary element 25 and/or after a fixed-amount of time. For example, primary logic 30 may detect the current level at nodes 16B and/or 16C. If the current level satisfies a current threshold, primary logic 30 may drive primary element 25 off. Otherwise, if the current level does not satisfy the current threshold, primary logic 30 may refrain from switching primary element 25 off and allow primary element 25 to remain switched-on.

In some examples, after driving primary element 25 on, primary logic 30 may rely on a counter or other time tracking technique to track the amount of time that has elapsed since primary element 25 was last turned on. Based on either a pre-defined value, a programmable value, and/or a calculated value, primary logic 30 may determine whether primary element 25 has been switched-on for an amount of time that is greater than or equal to a time threshold that equals the pre-defined value, the programmable value, and/or the calculated value (e.g., based on a measurement of the voltage across capacitor 34A that may approximate a maximum peak voltage of an AC input voltage with some variation across the phase of the AC input).

Primary logic 30 may turn primary element off if primary logic 30 determines that primary element 25 has been on for an amount of time that is greater than or equal to the time threshold. Varying the turn-on time of primary element 25 as a function of AC input voltage may ensure that the energy content per pulse remains substantially constant. Or put another way, if the product of the voltage across capacitor 34A and the duty cycle of primary element 25 is held constant, this can ensure that energy content per pulse of primary element 25 remains substantially constant.

In some examples, if control unit 12 determines that the output voltage at link 10 satisfies the desired output voltage of load 4, control unit 12 may determine that secondary side 5A does not need to request additional energy from primary side 7A to maintain the desired output voltage. In this case, control unit 12 may cause secondary element 26 to switch-off when the current level through secondary element 26 reaches the value of a minimum current threshold (e.g., zero amps) and refrain from switching back on until after a subsequent switching cycle of primary element 25.

In some examples, a primary objective of control unit 12 may be to wait to switch-off secondary element 26 at a last possible time before the current through the channel of secondary element 26 drops to the minimum current threshold (e.g., zero amps). Waiting to switch off secondary element 26 until the last possible time before the current reaches the minimum current threshold (e.g., zero amps) may enable control unit 12 to perform synchronous rectification with the greatest efficiency.

Accordingly, the flyback converter according to the circuits and techniques described herein provides a way for a secondary side controller to exchange information with the primary side without relying on a communication channel that is equipped with one or more opto-couplers other types of isolated data couplers that preserve the isolation between the primary and secondary sides of the flyback converter. Instead, the flyback converter simply relies on a secondary or synchronous rectification (“SR”) switching element and the inherent electrical characteristics of the flyback topology to control the flyback converter entirely from the secondary side.

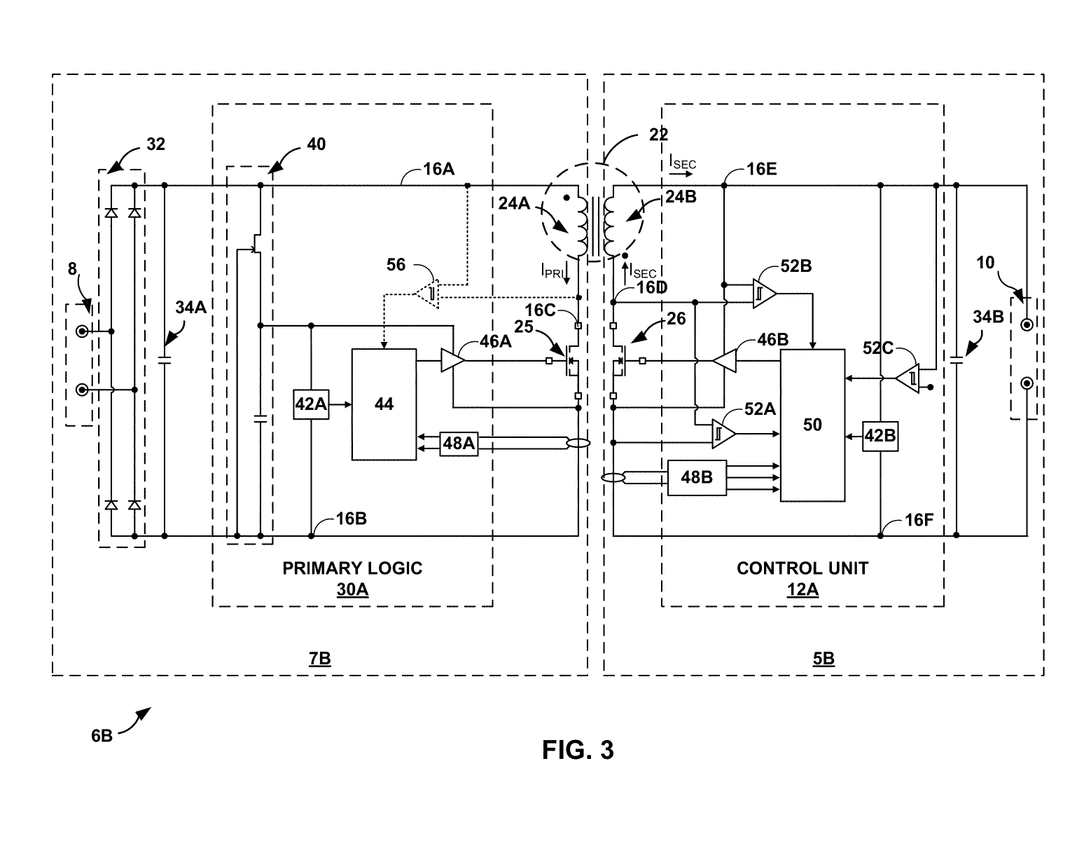

FIG. 3 is a conceptual diagram illustrating power converter 6B as one additional example of power converter 6 of system 1 shown in FIG. 1. For instance, power converter 6B of FIG. 3 represents a more detailed exemplary view of power converter 6 of system 1 from FIG. 1 and the electrical connections to power source 2 and load 4 provided by links 8 and 10 respectively.

Primary side 7B of power converter 6B is coupled to supply 2 at link 8 and primary winding 24A of transformer 22 and includes rectifier 32, capacitor 34A, primary logic 30A, and primary element 25. Secondary side 5B of power converter 6B is coupled to load 4 at link 10 and secondary winding 24B of transformer 22 and includes output capacitor 34B, control unit 12A, and secondary element 26.

In FIG. 3 primary logic 30A is one example of primary logic 30 of FIG. 2. Primary logic 30A includes start-up cell and depletion MOS 40 (“MOS” 40), state machine 44, under voltage lock-out unit (UVLO) 42A (e.g., an electronic circuit used to turn off power of state machine 44 in the event that the voltage across UVLO 42A drops below an operational threshold), driver 46A, and current sense unit 48A. In some examples, primary logic 30A may include optional comparator 56. In general, primary logic 30A (including elements 40, 42A, 46A, 48A, and optional element 56), may be configured to perform the functionality of primary logic 30 of FIG. 2 (e.g., to detect a voltage or current level at one or more nodes 16A-16C and based on the detected voltage or current level, cause primary element 25 to switch-on or switch-off).

State machine 44 of primary logic 30A may output a driver signal to driver 46A to cause primary element 25 to switch-on or switch-off at various times. Although described as being a state machine, state machine 44 represents any suitable combination of hardware, firmware, and/or software for providing a driver signal to driver 46A in accordance with the techniques described herein.

State machine 44 may transition from one operating state to the next based on voltage and/or current measurements taken across primary element 25 and other parts of primary side 7B of power converter 6B. The driver signal that state machine 44 outputs to driver 46A depends on the current operating state of state machine 44. For example, state machine 44 may receive a current sense signal from current sense unit 48A that represents a change to the polarity and/or amount of current being transferred through primary element 25. The change to the polarity and/or amount of the current and may cause state machine 44 to initiate a power conversion operation of primary side 7B of converter 6B and begin operating in an initial state. In the initial state, state machine 44 may output a driver signal to driver 46A that causes driver 46A to switch primary element 25 off.

Control unit 12A is one example of control unit 12 of FIG. 2. Control unit 12A includes state machine 50, under voltage lock-out unit (UVLO) 42B (e.g., an electronic circuit used to turn off power of state machine 50 in the event of the voltage across UVLO 42B drops below an operational threshold), driver 46B, and current sense unit 48B. In some examples, control unit 12A may include optional comparators 52A-52C (collectively “comparators 52”). In general, control unit 12A of FIG. 3, including elements 42B, 46B, 48B. 50, and 52A-52C, may be configured to control secondary element 26 to perform two functions. First, control unit 12A may control, from secondary side 5B, secondary element 26 consistent with synchronous rectification techniques. Second, control unit 12A may control secondary element 26 to cause energy to transfer, from secondary side 5B, via transformer 22, to primary side 7B, as a way to send information to primary side 7B, that triggers primary logic 30A to switch-on primary element 25.

State machine 50 of control unit 12 may output a driver signal to driver 46B to cause secondary element 26 to switch-on or switch-off at various times. Although described as being a state machine, state machine 50 represents any suitable combination of hardware, firmware, and/or software for providing a driver signal to driver 46B in accordance with the techniques described herein.

State machine 50 may transition from one operating state to the next based on voltage and/or current measurements taken across secondary element 26, and other parts of secondary side 5B (e.g., load 4, secondary winding 24B, etc.). The driver signal that state machine 50 outputs to driver 46B depends on the current operating state of state machine 50. For example, state machine 50 may derive a voltage level at link 10 and across load 4 based on various voltage comparator signals received from comparators 52. When the voltage level at link 10 drops below a given threshold, state machine 50 may initiate and begin operating in an initial state. While operating in the initial state, and when the secondary side current is less than or equal to a current threshold (e.g., zero amps), state machine 50 may output a driver signal to driver 46B causing driver 46B to switch-on secondary element 26 for a predetermined amount of time and switch-back-off secondary element 26 in order to transfer energy as information to primary side 7B of converter 6B to initiate a switching operation from secondary side 5B.

Current sense units 48A and 48B represent modules (e.g., any combination of hardware, firmware, and/or software) for measuring a current level at the output (e.g., drain terminal) of primary element 25 and secondary element 26 respectively. Comparators 52 and 56 may measure a difference between two respective voltage and/or current inputs and generate an output signal that represents the difference between the two inputs. State machines 44 and 50 may receive outputs (e.g., signals) from comparators 52 and 56 and/or current sense units 48A and 48B to determine whether or not to output a driver signal to drivers 46A and 46B, respectively.

Reference arrows are shown depicting the direction of positive current flow at the primary and secondary sides of power converter 6B. For instance, the label I_{PRI} shows the direction of positive current flow out of primary winding 24A at primary side 7B of power converter 6B. The label I_{SEC} shows the direction of positive current flow in to and out of primary winding 24B at secondary side 5B of power converter 6B.

In some examples, in accordance with techniques of this disclosure, state machine 50 and state machine 44 may be configured to operate according to a “master/slave” relationship and control scheme for causing power converter 6B to output power having a voltage or current level that is usable by load 4 and which is based on a voltage or current level of a power input from supply 2. For example, state machine 50 of control unit 12, may determine when secondary side 5B requires more energy from primary side 7B. In response to determining that secondary side 5B requires additional energy, state machine 50 may control secondary element 26 in such a way as to cause a transfer of energy from output capacitor 34B, via transformer 22, to primary side 7B. The transfer of energy may be interpreted by state machine 44 as a form of communication with state machine 50 that does not rely on any additional form of external communication channel (e.g., an external communication channel that is equipped with an opto-coupler, etc.). Responsive to the energy transfer from secondary side 5B and the resulting change to the voltage across primary element 25, state machine 44 may initiate power conversion operations of converter 6B. As such, state machine 44 may act as a “slave” that responds to information received from the “master” state machine 50.

In some examples, in accordance with techniques of this disclosure, state machine 50 and state machine 44 may be configured to operate according to an asynchronous control scheme for causing power converter 6B to output power having a voltage or current level that is usable by load 4 and which is based on a voltage or current level of a power input from supply 2. In other words, secondary side 5B of power converter 6B may be performing some secondary side control and primary side control. Primary side 7B of power converter 6B may react to the primary side control performed by secondary side 5B.

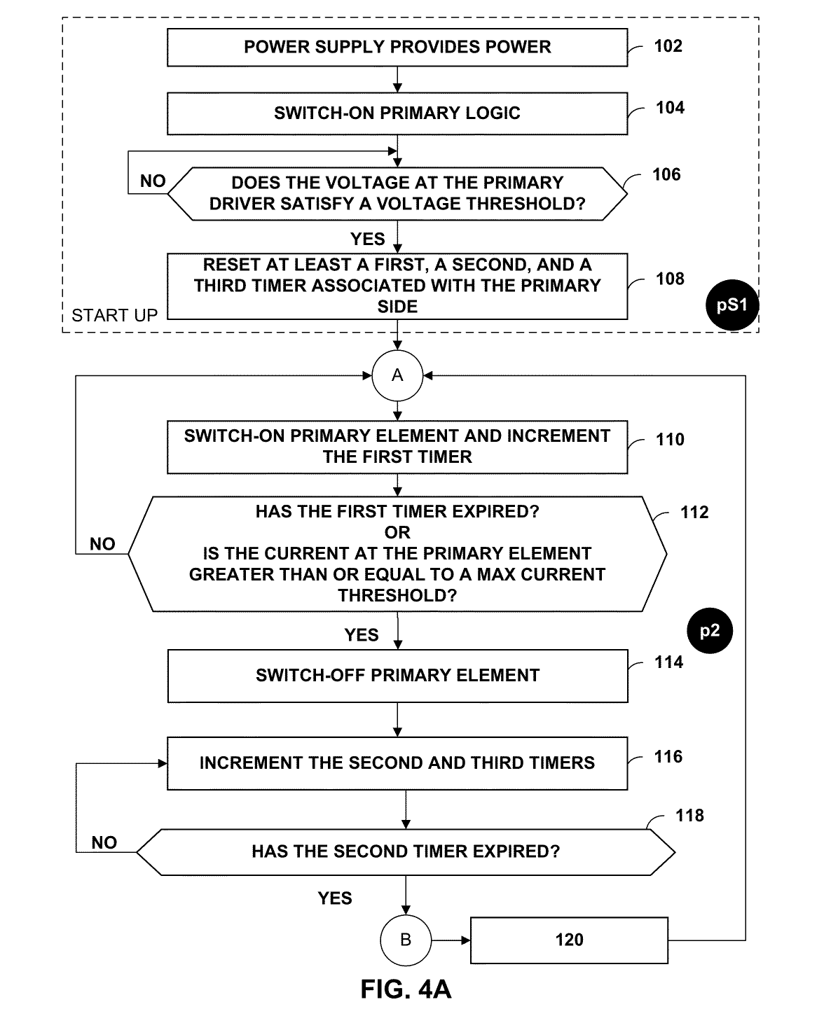

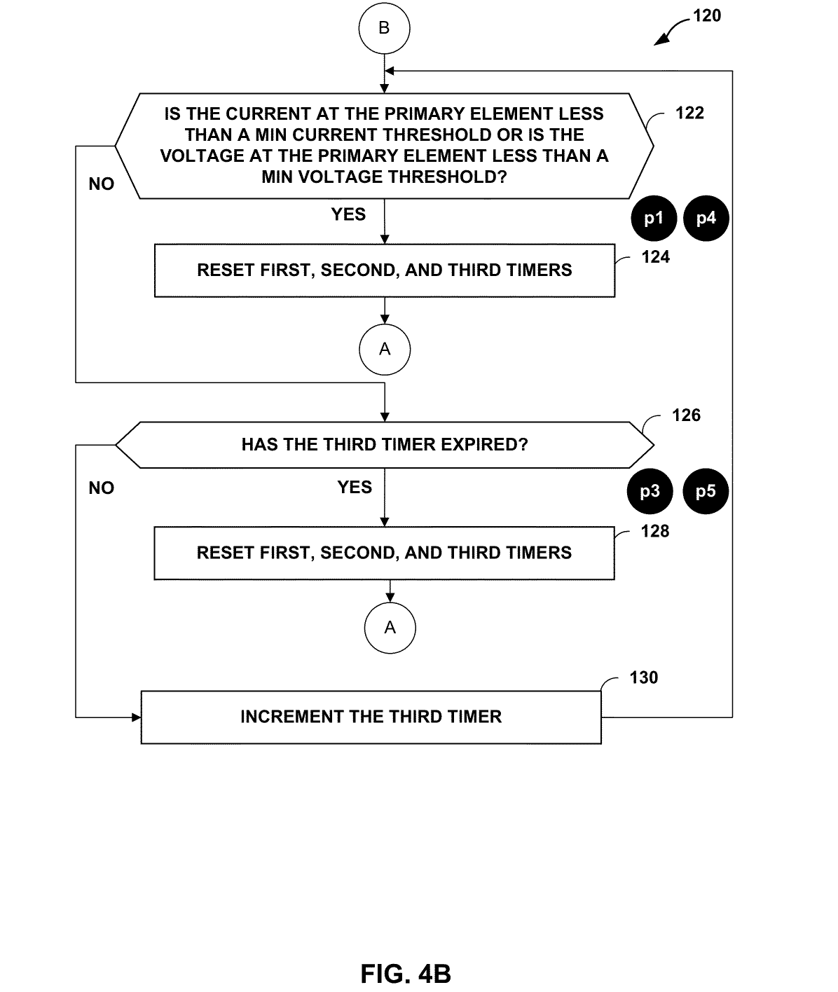

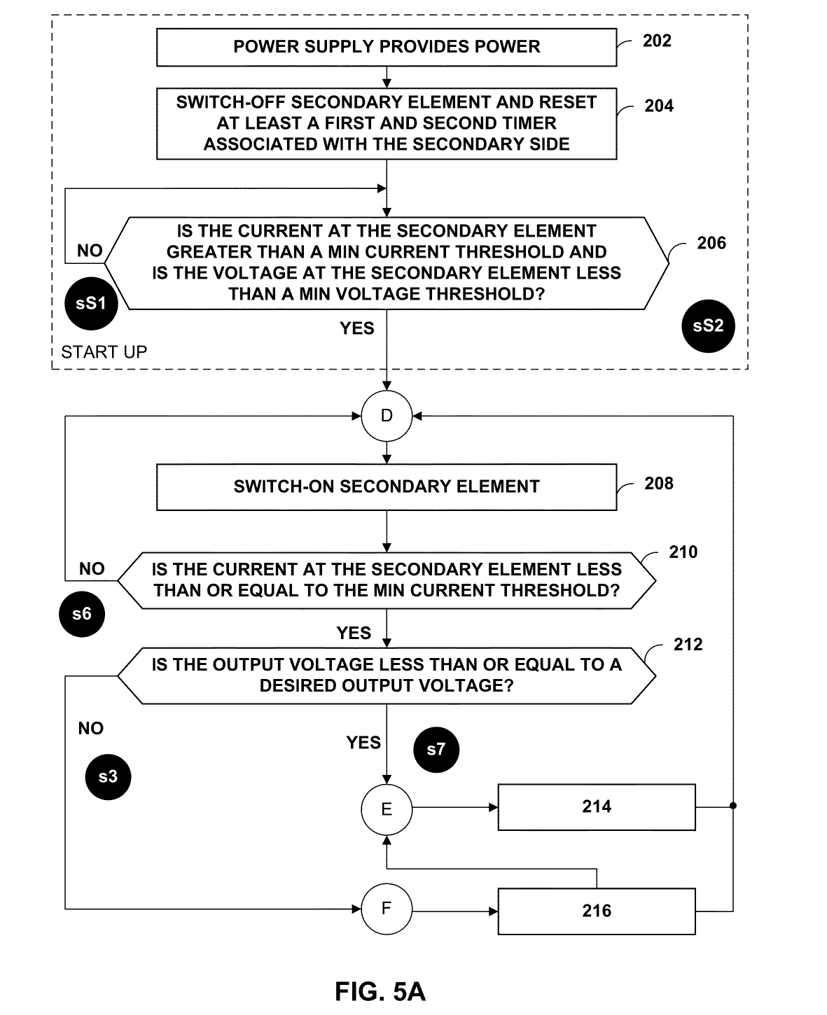

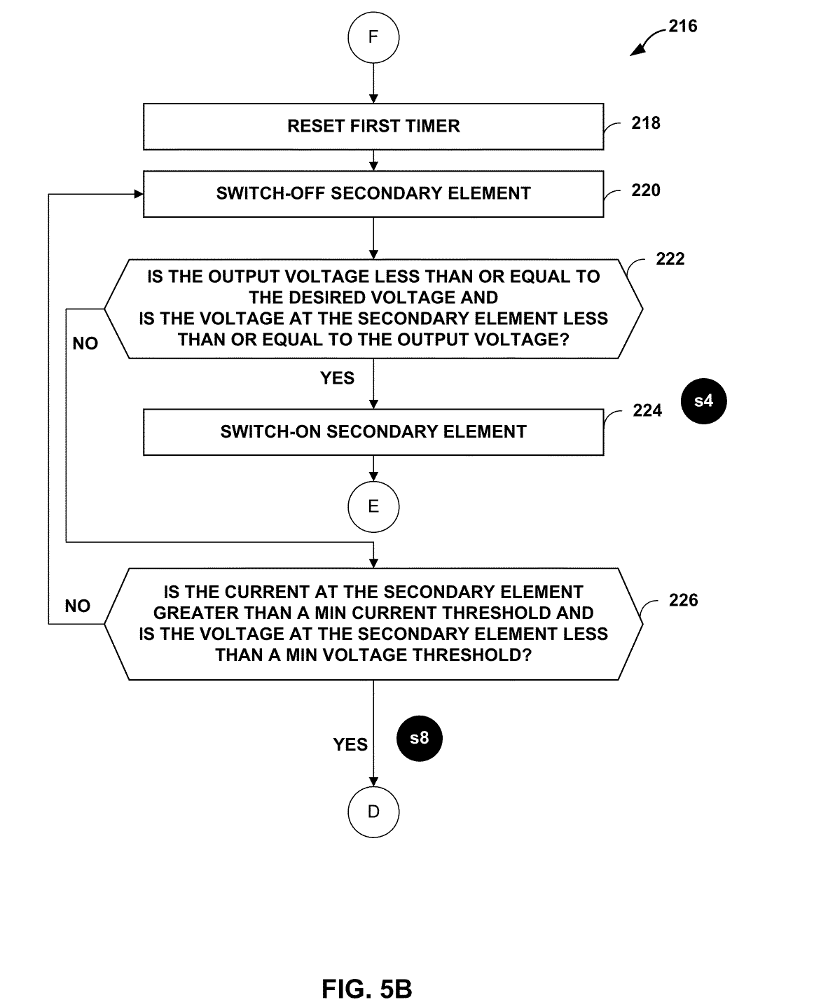

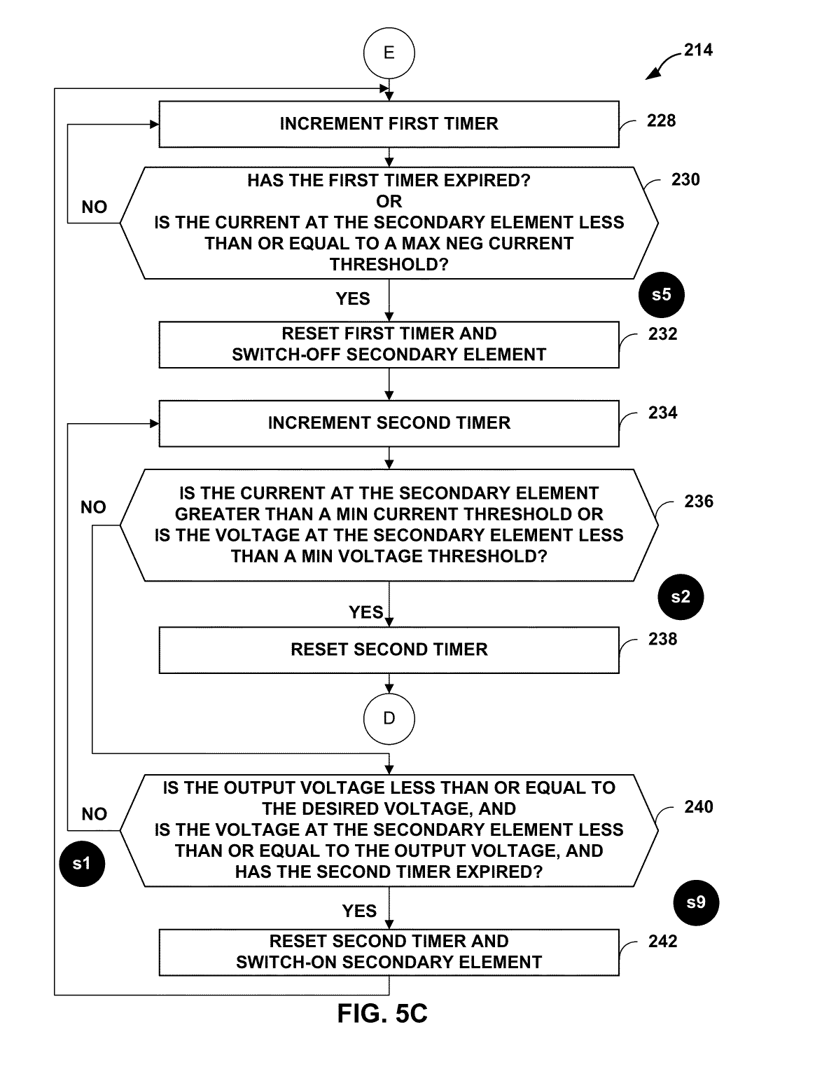

FIGS. 4A and 4B are flowcharts illustrating example operations of primary sides 7A or 7B of either power converters 6A or 6B, in accordance with one or more aspects of the present disclosure. FIGS. 5A-5C are flowcharts illustrating example operations of secondary sides 5A or 5B of either power converters 6A or 6B, in accordance with one or more aspects of the present disclosure. For ease of illustration, FIGS. 4A, 4B, and 5-5C are described below within the context of power converter 6B of FIG. 3 and system 1 of FIG. 1. For example, FIGS. 4A and 4B show operations 102-130 which may be performed by primary logic 30A of power converter 6B. FIGS. 5A-5C illustrate operations 202-242 being performed by control unit 12A of power converter 6B.

Each of the flowcharts of FIGS. 4A, 4B, and 5A-5C represent only one example set of operations performed by power converter 6B and additional operations may be used. For example, various time delay operations, that are not shown, may be introduced and be performed at primary side 7B or secondary side of power converter 6B in order to improve operating efficiency, robustness, or reliability of the power conversion.

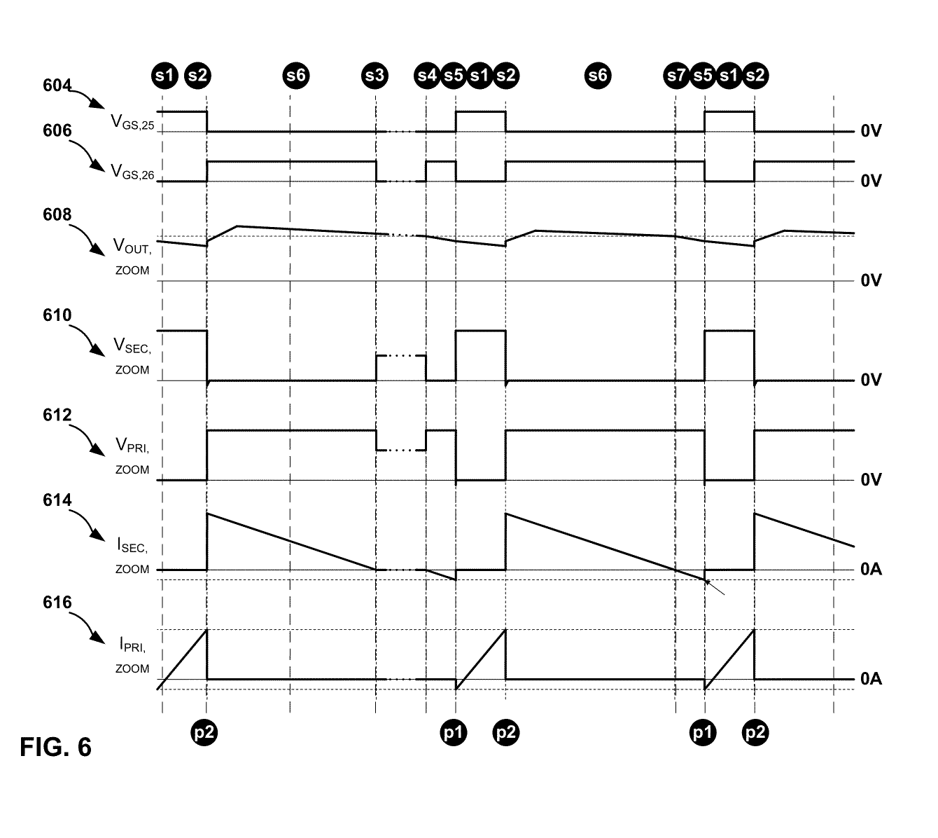

Each of FIGS. 4A, 4B, and 5A-5C include one or more black circles containing white text (e.g., “pS1”, “p2”, “sS1”, “sS2”, “s2”, etc.). Each of these black circles identifies a location of a flow chart being shown in FIGS. 4A, 4B, and 5A-5C with a name indicated by the white text. For ease of description, these locations are referenced in the description below regarding the various timing diagrams shown in FIGS. 6-1.

As shown in FIG. 4A, the operations of primary side 7B of power converter 6B include “a primary startup sequence” including operations 102-108. FIG. 4A shows that once power source 2 provides power to converter 6B (102), primary logic 30A, including primary driver 46A, may switch-on (104). In other words, primary logic 30A, including driver 46A, start-up to allow driver 46A to begin controlling primary element 25 according to information transferred from state machine 44. For example, a start-up circuit, including element 40, may charge driver 46A as the power from supply 2 charges capacitor 34A. When the voltage at driver 46A reaches a voltage threshold, state machine 44 may reset at least a first, a second, and a third timer associated with primary side 7B of power converter 6B (108). For example, state machine 44 may sense the voltage provided to driver 46A from a buffer capacitor of element 40 as part of the start-up circuit, and determine whether the voltage satisfies a voltage threshold. If the voltage does not satisfy the voltage threshold (106), state machine 44 may wait until driver 46A is ready to drive primary element 25. If the voltage does however satisfy the voltage threshold (108), state machine 44 may complete execution of the primary startup sequence by resetting the first, the second, and the third timers associated with primary side 7B to respective preset values.

In some examples, each of the first, second, and third timers may be set to different preset values depending on whether power converter 6B is undergoing a “start-up” cycle or during normal operation. For example, the third timer may be reset to one preset value during start-up and be set to a different preset value during operation. When state machine 44 completes execution of the primary startup sequence is identified in FIG. 4A as location “pS1”.

The first, second, and third timers may each represent techniques for introducing respective time delays into the performance of the operations by primary side 7B of power converter 6B. For example, the first timer may correspond to a maximum amount of time that state machine 44 causes primary element 25 to remain switched-on in order to energize transformer 22 with energy from supply 2. The second and third timers may correspond to, respectively to a minimum amount of time and a maximum amount of time, that state machine 44 causes primary element 25 to remain switched-off (e.g., while control unit 12 of secondary side 5B uses secondary element 26 to perform synchronous rectification, or control unit 12 causes secondary element 26 to switch-off after determining that the voltage across output capacitor 34B is high enough to satisfy the requirements of load 4 at link 10).

The operations of primary side 7B may further include “a control loop” that comprises operations 110-120. Upon completion of the primary startup sequence, state machine 44 may switch-on primary element 25 and increment the first timer (110). For example, state machine 44 may output a driver signal to driver 46A that causes driver 46A to drive primary element 25 on. By switching on primary element 25, primary winding 24A may output primary current (“I_{PRI}”) at node 16C and transformer 22 may begin to store energy.

State machine 44 may periodically check whether the first timer has expired (e.g., whether the timer value associated with the first timer meets or exceeds a time threshold) or whether the current at primary element 25 satisfies a current threshold (112) to determine whether sufficient time has passed for allowing energy to be stored from supply 2, at transformer 22. If state machine 44 determines that the first timer has not expired and that the current is not greater than or equal to a maximum current threshold, state machine 44 may continue to cause driver 46A to drive primary element 25 on and continue to periodically increment the first timer (110). If state machine 44 determines that the first timer has expired or that the current is greater than or equal to a maximum current threshold, state machine 44 may cause driver 46A to switch-off primary element 25 (114). In other words, in some examples, state machine 44 may cause primary side 7B to cease charging transformer 22 and switch-off primary element 25 if state machine 44 determines that a timer has elapsed that indicates that sufficient energy has been transferred from power supply 2. In some examples, state machine 44 may cause primary side 7B to cease charging transformer 22 and switch-off primary element 25 if state machine 44 determines that the primary current through primary element 25 is at a level that indicates that transformer 22 is likely to be fully energized with sufficient energy. When state machine 44 determines that either that the first timer has expired or that the primary current is at or equal to a maximum current threshold is identified in FIG. 4A as location “p2”.

After energizing transformer 22, state machine 44 may increment the second and third timers (116) until the second timer expires. When the second timer expires, state machine 44 may determine that the minimum amount of time has passed that is needed for secondary side 5B to the energy previously transferred, from primary side 7B, via transformer 22. In other words, state machine 44 may cause primary element 25 to remain switched-off for a minimum amount of time (corresponding to the second timer) to allow control unit 12A sufficient time to control secondary element 26 to perform synchronous rectification and to deplete the energy received from transformer 22. If the second timer associated with primary side 7B expires, state machine 44 may perform operations 120 to exit the main control loop for operating primary side 7B of power converter 6B (118).

As shown in FIG. 4B, operations 120 includes sub-operations 122-130 that primary side 7B of power converter 6B may perform after the second timer associated with primary side 7B expires. State machine 44 may determine whether, based on the primary voltage or primary current at primary element 25, primary side 7B has received a signal (e.g., in the form of energy transferred via the transformer core?) from secondary side 5B indicating that secondary side 5B is requesting additional energy from supply 2. Such a request for energy may comprise a control signal that indicates that the primary element should be switched on.

For example, state machine 44 may sense the primary voltage (e.g., detected by comparator 56) and/or the primary current (e.g., detected by current sense unit 48A) at primary element 25 and determine whether the primary current is less than or equal to a minimum current threshold (e.g., zero amps) or the primary voltage is less than or equal to a minimum voltage threshold (e.g., zero volts) (122). State machine 44 may interpret a primary voltage drop below the minimum voltage threshold and/or a primary current drop below the minimum current threshold as a transfer of energy that represents information being exchanged from secondary side 5B of power converter 6B, through transformer 22, and to primary side 7B of power converter 6B. State machine 44 may interpret such a voltage or current drop to be a request from secondary side 5B (e.g., control unit 12) to send additional energy from supply 2.

Upon detecting such a primary voltage below the minimum threshold and/or a primary current below the minimum current threshold, state machine 44 may reset the first, second, and third timers associated with primary side 7B (124) and complete execution of the control loop operations associated with primary side 7B. When state machine 44 detects the request from secondary side 5B to send more energy from supply 2 is identified in FIG. 4B as locations “p1” and “p4”.

If state machine 44 does not receive a request (e.g., as an energy transfer) from secondary side 5B for additional energy from supply 2, state machine 44 may determine whether the third timer has expired (126). In other words, state machine 44 may determine whether the maximum amount of time needed by secondary side 5B, to deplete the energy transferred to secondary side 5B, has passed since primary element 25 was last switched off. The maximum amount of time may be used when power converter 6B operates in a burst mode (e.g., where converter 6B “sleeps” and refrains from performing switching operations to minimize draw on supply 2) and/or as a way to prevent converter 6B from never restarting, after switching primary element 25 off.

Upon determining that primary element 25 has been switched-off for the maximum amount of time, state machine 44 may reset the first, second, and third timers associated with primary side 7B (128). Otherwise, state machine 44 may increment the third timer (130) and continue to cause primary element 25 to remain switched-off until either the voltage or current at primary element 25 drops below the minimum corresponding threshold, or the maximum switch-off time has passed. When state machine 44 determines that primary element 25 has been switched off for a maximum amount of time is identified in FIG. 4B as locations “p3” and “p5”.

As shown in FIG. 5A, the operations of secondary side 5B of power converter 6B may include “a secondary startup sequence” that includes operations 202-206. FIG. 5A shows that after power supply 2 provides power to power converter 6B (e.g., by transmitting a voltage and/or current across links 8 and to the inputs of power converter 6B) (202), state machine 50 of control unit 12A may command driver 46B to switch-off secondary element 26. State machine 50 may reset at least a first and second timer associated with secondary side 5B of power converter 6B (204). In other words, state machine 50 may set the first and second timers to preset values.

The first and second timers associated with secondary side 5B of power converter 6B may each represent techniques for introducing respective time delays into the performance of the operations by secondary side 5B of power converter 6B. For example, the first timer associated with secondary side 5B may correspond to the maximum amount of time that control unit 12A causes secondary element 26 to be switched-on. The second timer associated with secondary side 5B of power converter 6B may correspond to the maximum amount of time that control unit 12A causes secondary element 26 to be switched-off.

State machine 50 may receive inputs from current sense unit 48B, comparators 52A-52B, etc. State machine 50 of control unit 12 may determine whether the current at secondary element 26 (“I_{SEC}”) is greater than a minimum current threshold (e.g., zero amps) and the voltage at secondary element 26 is less than or equal to a minimum voltage threshold (e.g., zero volts) (206). If not, state machine 50 may continue to operate in the secondary startup sequence and periodically check whether the current at secondary element 26 is greater than the minimum current threshold and the voltage at secondary element 26 is less than or equal to the minimum voltage threshold. For example, state machine 50 of control unit 12A may sense the secondary current based on an output from current sense 48B. State machine 50 may determine the voltage across secondary element 26 based on the output from one or more of comparators 52A-52C. The period of continued execution by control unit 12A of the secondary startup sequence is identified in FIG. 5A as location “sS1”.

If, however, state machine 50 determines that the current at secondary element 26 is greater than the minimum current threshold and the voltage at secondary element 26 is less than or equal to the minimum voltage threshold (206), state machine 50 may complete execution of the secondary startup sequence. When state machine 50 completes execution of the secondary startup sequence is identified in FIG. 5A as location “sS2”. Location “sS2” is also when state machine 50 determines that primary element 25 has switched off.

The operations associated with secondary side 5B of power converter 6B may include a control loop comprising operations 208-216. Upon completion of the secondary startup sequence associated with secondary side 5B, and after primary element 25 has switched off, state machine 50 may switch-on secondary element 26 consistent with synchronous rectification (208). For example, state machine 50 may output a driver signal to driver 46B that causes driver 46B to drive secondary element 26 on. While secondary element 26 is switched-on, state machine 50 may monitor the secondary side current I_{SEC} and the voltage across output capacitor 34B to determine first whether to switch-off secondary element 26 consistent with synchronous rectification, and second if and when to signal to primary side 7B, the need for more energy at secondary side 5B. That is, whether to signal the need for more energy by either holding secondary element 26 switched-on for a predetermined amount of time after the secondary current falls at or below a current threshold (e.g., zero amps), or after already having turned secondary element 26 off after the secondary current fell at or below the current threshold, cycling secondary element 26 back on and off, to cause an energy transfer to primary side 7B to signal the need for more energy at secondary side 5B.

State machine 50 of control unit 12A may receive information from current sense unit 48B that indicates the amount of current traveling through secondary element 26 when secondary element 26 is switched-on. State machine 50 may periodically determine whether the current at secondary element 26 is less than or equal to the minimum current threshold (e.g., zero amps) (210). When state machine 50 determines whether the secondary current is less than or equal to the minimum current threshold is identified in FIG. 5A as location s6.

Consistent with synchronous rectification, if the current is not less than or equal to the minimum current threshold, state machine 50 may continue to drive secondary element 26 on. However, if the secondary current at secondary element 26 is less than or equal to the minimum current threshold, state machine 50 may determine whether to request additional energy from primary side 7B by determining whether the output voltage is less than or equal to a desired output voltage (e.g., five volts) (212).

If the output voltage is greater than the desired output voltage, state machine 50 may infer that secondary side 5B has sufficient energy to support the needs of load 4 and may complete execution of the control loop operations by performing operations 214 (consistent with synchronous rectification) without requesting additional energy from primary side 7B. If however the output voltage is less than or equal to the desired output voltage, state machine 50 may infer that secondary side 5B does not have sufficient energy to support the needs of load 4, and may complete execution of the control loop operations associated with secondary side 5B by performing operations 216, to request additional energy from primary side 7B. When state machine 50 determines that the output voltage is less than or equal to the desired output voltage is identified in FIG. 5A as location s3 and when state machine 50 determines that the output voltage is not less than or equal to the desired output voltage is identified in FIG. 5A as location s7.

FIG. 5B shows operations 218-226 that make up operations 216 shown in FIG. 5A. State machine 50 may reset the first timer associated with secondary side 5B of power converter 6B (218) and switch-off secondary element 26 (220) consistent with synchronous rectification, from secondary side 5B. State machine 50 may receive information from comparators 52A-52C to determine whether the output voltage (e.g., the voltage across capacitor 34B) is less than or equal to the desired voltage and to further determine whether the secondary voltage at secondary element 26 is less than or equal to the output voltage (222). If the condition of operation 222 is true, state machine 50 may initiate the control of secondary element 26 to transfer information, via transformer 22, to primary side 7B of power converter 6B to cause primary side 7B to send more energy from source 2 via transformer 22. To transfer of energy from secondary side 5B, via transformer 22, to primary side 7B, state machine 50 may switch-on secondary element 26 (224) and may perform operations 214 of FIG. 5A. When state machine 50 initiates the cycling on and off of secondary element 26 is identified in FIG. 5B as location s7.

If the condition of operation 222 is not true (e.g., the output voltage is not less than or equal to the desired voltage and the secondary voltage at secondary element 26 is not less than or equal to the output voltage), state machine 50 may determine that additional energy from primary side 7B of power converter 6B is not needed to maintain the desired output voltage and may determine whether to complete execution of the control loop operations associated with secondary side 5B. State machine 50 may determine whether the secondary current at secondary element 26 is greater than a minimum current threshold (e.g., zero amps) and whether the secondary voltage at secondary element 26 is less than or equal to a minimum voltage threshold (e.g., zero volts) (226). If the condition of operation 226 is true, state machine 50 may complete execution of the control loop operations associated with secondary side 5B of converter 6B. Otherwise, state machine 50 may continue to switch-off secondary element 26 (220) and re-evaluate whether the output voltage is less than the desired output voltage and whether the secondary voltage is less than or equal to the output voltage (222). When state machine 50 determines that the secondary current at secondary element 26 is greater than the minimum current threshold and that the secondary voltage at secondary element 26 is less than or equal to the minimum voltage threshold is identified in FIG. 5B as location s8.

FIG. 5C shows sub-operations 228-242 that make up operations 214 shown in FIG. 5A. Sub-operations 228-232 represent the completion of the cycling on and off of secondary element 26 to cause an information (e.g., energy) to transfer from secondary side 5B of power converter 6B to primary side 7B to signal to primary side 7B that secondary side 5B needs more energy.

After incrementing the first timer associated with secondary side 5B of power converter 6B (228), state machine 50 may determine whether the first timer has expired or whether the secondary current at secondary element 26 is less than or equal to a maximum negative current threshold (230). The maximum negative current threshold corresponds to a negative current level typically observed by state machine 50 when current is flowing through the body diode of secondary element 26 and the voltage across secondary element 26 is approximately equivalent to the forward voltage drop of the body diode (e.g., −0.7V). In other words, state machine 50 may determine whether the current through the body diode of secondary element 26 and the forward voltage drop of the body diode are such that secondary element 26 can switch back-off to complete the energy transfer, from secondary side 5B, via transformer 22, to primary side 7B. If state machine 50 determines that either condition of operation 230 is not satisfied, state machine 50 may increment the first timer periodically until either condition is satisfied.

Once either condition is satisfied, state machine 50 may complete the cycling on and off of secondary element 26, and complete the transfer of energy from secondary side 5B to primary side 7B, by resetting the first timer and switching-off secondary element 26 (232). When state machine 50 completes the cycling on and off of secondary element 26 to finish the transfer of energy from secondary side 5B, via transformer 22, to primary side 7B, is identified as location s5 in FIG. 5C.

State machine 50 may increment the second timer associated with secondary side 5B of power converter 6B (234). To determine when primary element 25 has finished transferring energy from source 2 via transformer 22, state machine 50 may evaluate whether the secondary current at secondary element 26 has a positive polarity (e.g., greater than a minimum current threshold of zero amps) or whether the secondary voltage at secondary element 26 has a negative polarity (e.g., less than or equal to a minimum voltage threshold of zero volts) (236).

If the condition of operation 236 is true, state machine 50 may complete execution of the control loop operations associated with secondary side 5B of converter 6B. State machine 50 may infer that when a secondary current is positive or otherwise exceeds a minimum current threshold when the secondary voltage is negative or otherwise less than or equal to a minimum voltage threshold, that sufficient energy from primary side 7B has built up at transformer 22 and is ready to be released at secondary side 5B. When state machine 50 determines that the secondary current at secondary element 26 is positive or otherwise greater than the minimum current threshold and that the secondary voltage at secondary element 26 is negative or otherwise less than or equal to the minimum voltage threshold is identified in FIG. 5C as location s2.

If however the condition of operation 236 is not true, state machine 50 may determine whether the output voltage is less than or equal to the desired output voltage (e.g., five volts), whether the secondary voltage at secondary element 26 is less than or equal to the output voltage, and whether the second timer associated with secondary side 5B of power converter 6B has expired (240). If at least one of the conditions of operation 240 is not true, state machine 50 may increment the second timer and perform operation 236 to determine whether to complete execution of the control loop operations of secondary side 5B. If each of the conditions of operation 240 is true, state machine 50 may reset the second timer and switch-on secondary element 26 (242) and perform operations 228 to 230 (according to FIG. 5c) to determine whether to complete execution of the control loop operations of secondary side 5B. Location s1 of FIG. 5C shows when one or more of the conditions of operation 240 is not true and location s9 illustrates when each of the conditions of operation 240 is true.

In some examples, state machine 50 may vary the first timer associated with secondary side 5B to vary the amount of energy transferred from secondary side 5B to primary side 7B. In some examples, state machine 50 may perform two or more simultaneous energy transfers to indicate a further variation of the amount of energy being transferred to primary side 7B. In any event, the energy transferred via transformer 22 from secondary side 5B to primary side 7B of power converter 6B may cause state machine 44 to alter the duty cycle associated with primary element 25 (e.g., as a function of the amount of load determined by state machine 50 at the output of converter 6B). For instance, in some “light” or small load conditions, secondary side 5B may send energy to primary side 7B to cause state machine 44 to reduce the duty cycle of primary element 25 to ensure that less energy per time unit is transferred to secondary side 5B. For example, primary side 7b may rely on a two voltage thresholds. If the voltage across primary element 25 exceeds the first voltage threshold (e.g., zero volts or a negative clamping voltage associated with primary element 25), then primary side 7B may perform normal switching operations and switch on to transfer a normal amount of energy to secondary side 7B. If however the voltage exceeds the second voltage threshold (e.g., 20V), then primary side 7B may perform modified switching operations and switch on to transfer a less than normal amount of energy to secondary side 7B.

In some examples, the driver signals produced by driver 46A and 46B to switch-on or switch-off, respectively, secondary element 26 and primary element 25 may contain a fixed quantity of pulses per packet (e.g., 1, 2, 3, . . . , N, N+1). In some examples, the driver signals use a varying quantity of pulses per packet depending on the output voltage.

In some examples, the primary startup sequence associated with primary side 7B of converter 6B may include a start-up sequence, where first: a capacitor supplying the gate drive of primary element 25 is charged. Then primary element 25 may be operated with a fixed duty cycle using (e.g., having a fixed frequency operation). The start-up sequence may complete once the output voltage at secondary side 5B reaches a desired output voltage threshold. Once this voltage is established, the gate drive of primary element 25 on primary side 7B may receive a voltage or draw a current from an auxiliary winding of transformer 22 (not shown) and full secondary side operation consistent with synchronous rectification using secondary element 26 may begin. Control unit 12A at secondary side 5B may be supplied from the output voltage or through DC/DC converter or linear voltage regulators.

In some examples, power converter 6B may have varying output voltages being controlled or otherwise regulated from control unit 12A of secondary side 5B. In some examples, the output voltage may vary between five volt and twelve volt operation.

In some examples, secondary element 26 may be switched-on based the amount of current flowing through the body diode of secondary element 26. In some examples, secondary element 26 may be switched on based on a whether voltage across the load terminals (e.g., the drain and source terminals) of secondary element 26 or a voltage at secondary side winding 24B of transformer 22 falls below a particular voltage threshold.

Secondary element 26 may be switched off based on the amount of current through secondary element 26 (e.g., switching-off secondary element 26 once the current falls below a current threshold). In some examples, a timer set to a fixed amount of time after switching-on the secondary element 26 may be used to determine when to switch-off secondary element 26. The fixed amount of time may be calculated from the output voltage and may be varied inversely proportional to the output voltage.

In some examples, a zero-current transition associated with the secondary current is detected on secondary side 5B by control unit 12A and secondary element 26 may be switched-off in response to the zero-current transition and after a time delay (e.g., the time delay being an amount of time that is inversely proportional to the output voltage).

The time may be a fixed delay time during which a zero voltage switching (ZVS) operation of primary element 25 may be performed. The ZVS operation being achieved at the lowest limit of the output voltage may be advantageous for some fixed output voltage power converters. For example, power converter 6B may improve its efficiency by performing ZVS techniques as a way to reduce the amount of energy that power converter 6B uses to perform switching operations. The switching losses occurring at primary element 25 during the transition from the off-state to the on-state may be lowest when the voltage across the primary element 25 is approximately zero. In general, flyback converters like power converter 6B can save energy, resulting in improved efficiency, by causing their primary elements to switch-on, during a zero voltage condition. Other flyback converters typically perform ZVS from the primary side by measuring, with a primary controller, the voltage and/or current at the primary element, and causing the primary element to switch-on, when the primary controller determines that a zero voltage condition is occurring at the primary switch (e.g., when the drain-to-source capacitance associated with the primary switch is at its lowest level). In contrast to other flyback converters, power converter 6B according to the techniques and circuits described herein, may be operated such that control unit 12, from secondary side 5A, initiates ZVS, by transmitting information to primary side 7A and primary logic 30 by transferring energy via transformer 22.

In any event, to achieve the increased efficiency of ZVS, the energy transfer from secondary side 5A may cause primary logic 30 to switch on primary element 25 when the voltage across primary element 25 falls at or below zero volts. That is, switching-on primary element 25 when the voltage across primary element 25 is less than or equal to zero volts may reduce an amount of efficiency that is lost due to the switch-on of primary element 25. For example, once the voltage across primary element 25 falls below zero volts, the body diode of primary element 25 will turn on and clamp the voltage across primary element 25 to a clamping voltage associated with the body diode (e.g., −0.7V). With the voltage clamped at the clamping voltage, the voltage may not drop further. Since turning on primary element precisely when the voltage across primary element is exactly at zero volts requires advanced timing and is impractical for most applications (e.g., too expensive), causing primary element 25 to turn on when the voltage is at its clamping voltage may be sufficient to achieve ZVS.

In some examples, power converter 6B may have more than one output stage. For example, secondary side 5B of power converter 6B may have more than one output stage from which power converter 6B may provide different output voltages or subsequent DC/DC conversion using multiple output stages.

Although the techniques are mostly described with respect to secondary side 5B of power converter 6B transferring energy to primary side 7B, primary side 7B may transfer energy to secondary side 5B using similar techniques. For instance, by cycling primary element 25 on and off to cause an energy transfer from primary side 7B through transformer 22 and to secondary side 5B, power converter 6B may establish a communication link, via transformer 22, between state machine 44 at primary side 7B and state machine 50 at secondary side 5B. In other words, primary side 7B may transfer a specific amount of energy to secondary side 5B that causes a change in voltage or current at secondary side 5B which is interpreted by state machine 50 as a signal to perform a function at secondary side 5B.

FIGS. 6-11 are timing diagrams illustrating voltage and current characteristics of either of the example power converters, while performing the operations of FIGS. 4A, 4B, and 5A-5C, in accordance with one or more aspects of the present disclosure. Each of FIGS. 6-11 include multiple voltage and current plots showing various voltage and current levels at different portions of power converter 6B when operations are being performed by state machines 44 and 50 at the locations sS1, sS2, s1-s9, pS1, and p1-p5 of the flow charts of FIGS. 4A, 4B, and 5A-5C. For ease of description, FIGS. 6-11 are described below within the context of power converter 6B of FIG. 3.

FIG. 6 is a timing diagram illustrating voltage and current characteristics of power converter 6B of FIG. 3 during an example steady-state operation of power converter 6B, in accordance with one or more aspects of the present disclosure. FIG. 6 shows plots 604-616 which each represent different voltage or current levels at various parts of power converter 6B during a steady state operation of power converter 6B. Plots 604-616 are not necessarily drawn to scale.

Plots 604 and 606 show the gate or driver signals (e.g., the voltage between the gate and source terminals) of elements 25 and 26, respectively. Plots 612 and 616 show the primary voltage and the primary current level at primary element 25 and plots 610 and 614 illustrate the secondary voltage and the secondary current levels at secondary element 26. Plot 608 shows the output voltage (e.g., the voltage level at link 10 and across capacitor 34B) of converter 6B as the primary voltage and current levels at primary element 25 and the secondary voltage and current levels at secondary element 26 change over time during steady state operation of power converter 6B.

For example, the far left of plot 606 shows the gate voltage at secondary element 26 going high at s2 after the gate voltage at primary element 25, shown in ploy 604. goes low, which is consistent with synchronous rectification. At s3, the secondary side current shown in 614 starts to fall at or below zero amps and the gate voltage at secondary element 26 goes low, consistent with synchronous rectification. At s4, because the output voltage shown by plot 608 drops below a desired output voltage threshold, the gate voltage at secondary element 26 shown in plot 606 goes back high to initiate a transfer of energy from secondary side 5B, via transformer 22, to primary side 7B. The gate voltage at secondary element 26 shown in plot 606 remains high until the secondary current of plot 614 reaches the minimum current threshold (e.g., the point at which the body diode of secondary element 26 conducts). This completes the transfer of energy from secondary side 5B, via transformer 22, to primary side 7B, as shown in plot 616 at s5 where the primary current into primary element 25 goes immediately negative and the voltage across primary element 25 also goes negative. At s5, the negative primary current and/or negative voltage across primary element 25 causes primary element 25 to switch on and begin transferring energy from primary side 7B.

Just right of the center of plot 606, plot 606 again shows the gate voltage at secondary element 26 going high at s2 after the gate voltage at primary element 25, shown in ploy 604, goes low, which is consistent with synchronous rectification. At s7, the secondary side current shown in 614 starts to fall at or below zero amps. Rather than the gate voltage at secondary element 26 going low, consistent with synchronous rectification, the gate voltage at secondary element 26 at s7 stays high. The gate voltage at s7 stays high because the output voltage shown by plot 608 drops below the desired output voltage threshold. Keeping the gate voltage of secondary element 26 high when the secondary side current falls below zero amps, which is inconsistent with synchronous rectification, causes energy to transfer via transformer 22, from secondary side 5B to primary side 7B. The gate voltage at secondary element 26 shown in plot 606 remains high until the secondary current of plot 614 reaches the minimum current threshold at s5 (e.g., the point at which the body diode of secondary element 26 conducts). This completes the transfer of energy from secondary side 5B, via transformer 22, to primary side 7B, as shown in plot 616 at s5 where the primary current into primary element 25 goes immediately negative and the voltage across primary element 25 also goes negative. At s5, the negative primary current and/or negative voltage across primary element 25 causes primary element 25 to switch on and begin transferring energy from primary side 7B.

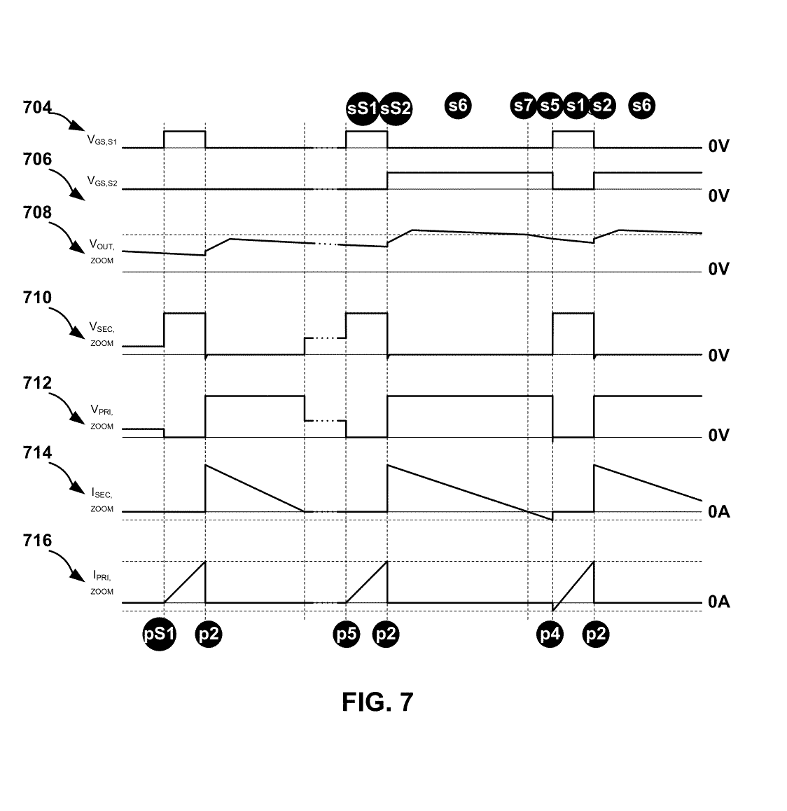

FIG. 7 is a timing diagram illustrating voltage and current characteristics of power converter 6B of FIG. 3 during an example startup operation of power converter 6B, in accordance with one or more aspects of the present disclosure. FIG. 7 shows plots 704-716 which each represent different voltage or current levels at various parts of power converter 6B. Plots 704-716 are not necessarily drawn to scale.

Plots 704 and 706 show the gate or driver signals (e.g., the voltage between the gate and source terminals) of elements 25 and 26, respectively. Plots 712 and 716 show the primary voltage and the primary current level at primary element 25 and plots 710 and 714 illustrate the secondary voltage and the secondary current levels at secondary element 26. Plot 708 shows the output voltage (e.g., the voltage level at link 10 and across capacitor 34B) of converter 6B as the primary voltage and current levels at primary element 25 and the secondary voltage and current levels at secondary element 26 change over time during an example startup operation of power converter 6B. The start-up of driver 46A and the startup of the other components of primary side 7B of converter 6B, other than primary element 26, may occur prior to the start of the startup operation shown in FIG. 7

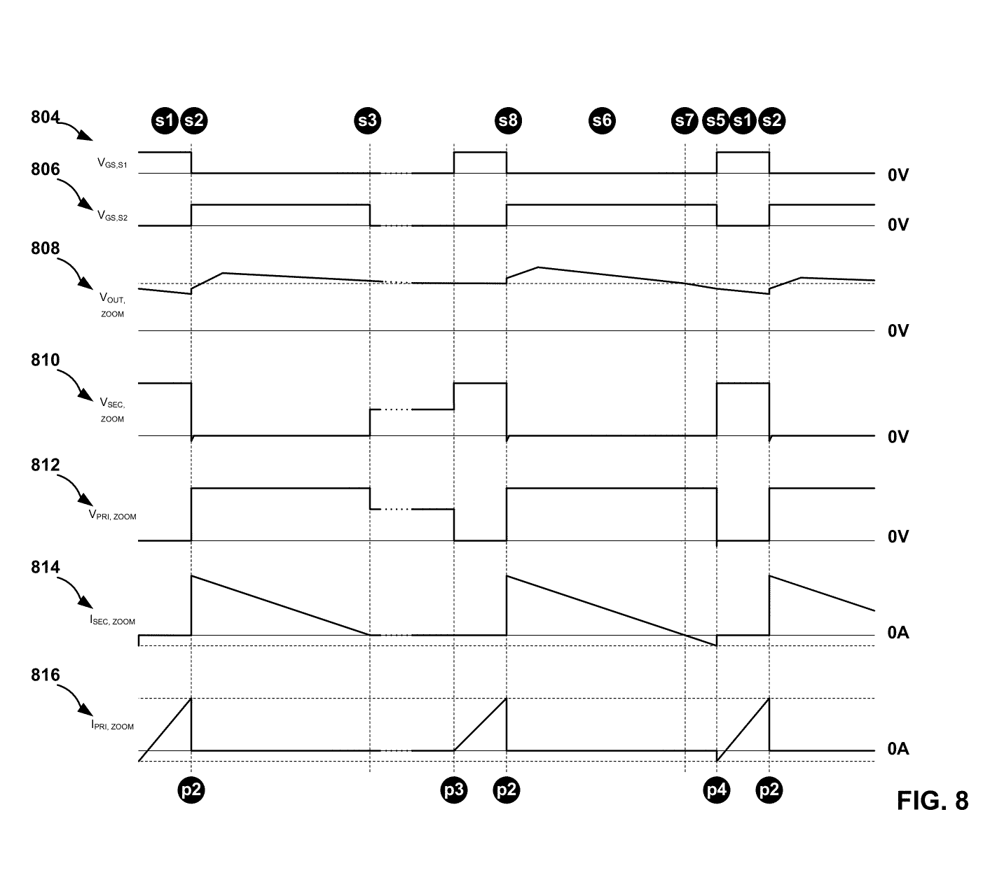

FIG. 8 is a timing diagram illustrating voltage and current characteristics of power converter 6B of FIG. 3 during an example operation of power converter 6B in which the cycling on and off of secondary element 26 has an insufficient duty cycle (e.g., the cycling of secondary element 26 terminates prior to the expiration of the first timer associated with secondary side 5B), in accordance with one or more aspects of the present disclosure. FIG. 8 shows plots 804-816 which each represent different voltage or current levels at various parts of power converter 6B. Plots 804-816 are not necessarily drawn to scale.

Plots 804 and 806 show the gate control single (e.g., the voltage between the gate and source terminals) of elements 25 and 26, respectively. Plots 812 and 816 show the primary voltage and the primary current level at primary element 25 and plots 810 and 814 illustrate the secondary voltage and the secondary current levels at secondary element 26. Plot 808 shows the output voltage (e.g., the voltage level at link 10 and across capacitor 34B) of converter 6B as the primary voltage and current levels at primary element 25 and the secondary voltage and current levels at secondary element 26 change over time. FIG. 8 shows that if the first timer associated with secondary side 5B is too short in duration, an over voltage on secondary side 5B may be created.

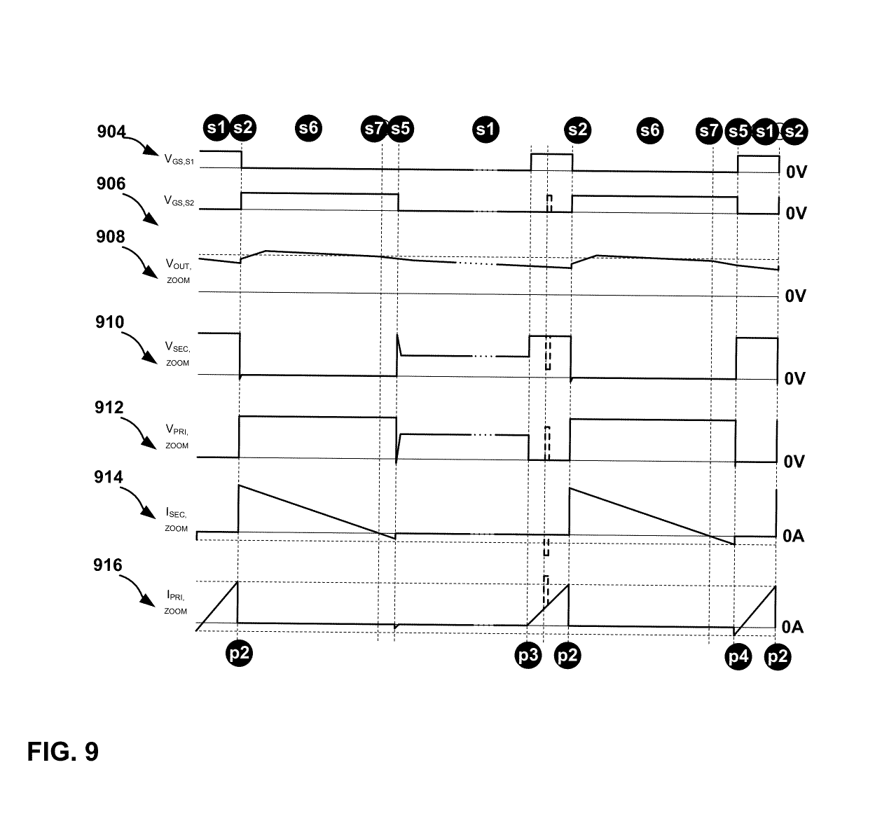

FIG. 9 is a timing diagram illustrating voltage and current characteristics of power converter 6B of FIG. 3 during an example operation of power converter 6B in which primary side 7B misses a request from secondary side 5B or a primary element switch-on, in accordance with one or more aspects of the present disclosure. FIG. 9 shows plots 904-916 which each represent different voltage or current levels at various parts of power converter 6B. Plots 904-916 are not necessarily drawn to scale.

Plots 904 and 906 show the gate or driver signals (e.g., the voltage between the gate and source terminals) of elements 25 and 26, respectively. Plots 912 and 916 show the primary voltage and the primary current level at primary element 25 and plots 910 and 914 illustrate the secondary voltage and the secondary current levels at secondary element 26. Plot 908 shows the output voltage (e.g., the voltage level at link 10 and across capacitor 34B) of converter 6B as the primary voltage and current levels at primary element 25 and the secondary voltage and current levels at secondary element 26 change over time. FIG. 9 shows what happens if primary side 7B misses a request from secondary side 5B for a primary element switch-on and the second timer associated with primary side 7B expires. FIG. 9 also shows that the by comparing the secondary voltage at secondary element 26 to the output voltage, the simultaneous expiration of the second timer associated with primary side 7B and the second timer associated with secondary side 5B can be prevented when the output voltage is less than or equal to the desired output voltage. Such a comparison may prevent primary element 25 and secondary element 26 from being switched on without relying on any additional communication links or channels outside of transformer 22 for enabling communication between a secondary side controller and a primary side controller.

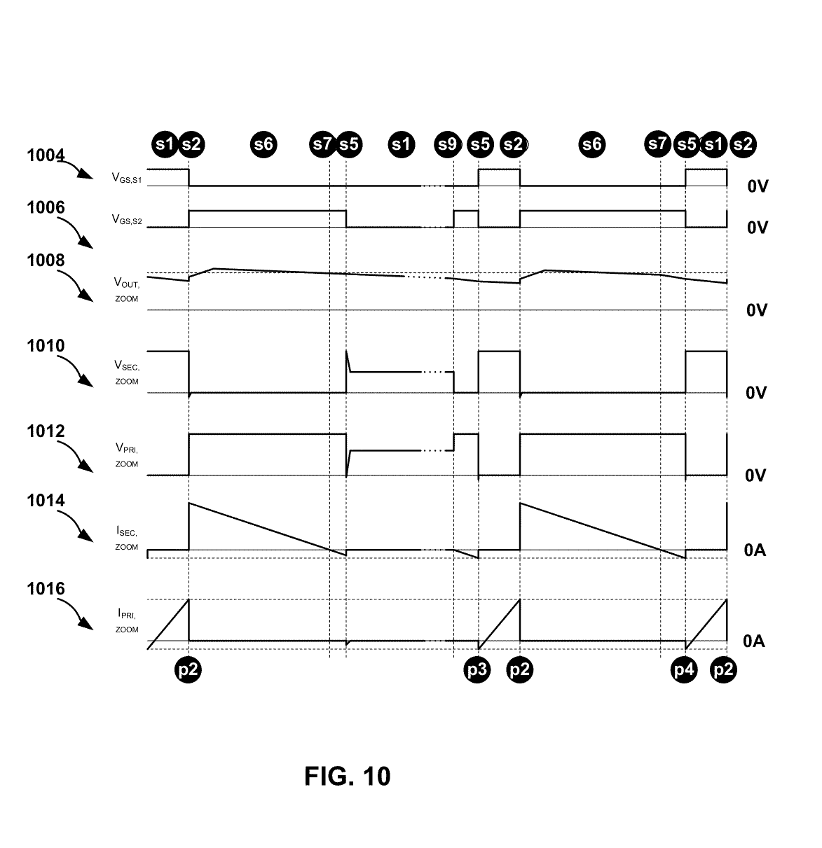

FIG. 10 is a timing diagram illustrating voltage and current characteristics of power converter 6B of FIG. 3 during an example operation of power converter 6B in which primary side 7B misses a request from secondary side 5B or a primary element switch-on, in accordance with one or more aspects of the present disclosure. FIG. 10 shows plots 1004-1016 which each represent different voltage or current levels at various parts of power converter 6B. Plots 1004-1016 are not necessarily drawn to scale.

Plots 1004 and 1006 show the gate or driver signals (e.g., the voltage between the gate and source terminals) of elements 25 and 26, respectively. Plots 1012 and 1016 show the primary voltage and the primary current level at primary element 25 and plots 1010 and 1014 illustrate the secondary voltage and the secondary current levels at secondary element 26. Plot 1008 shows the output voltage (e.g., the voltage level at link 10 and across capacitor 34B) of converter 6B as the primary voltage and current levels at primary element 25 and the secondary voltage and current levels at secondary element 26 change over time. FIG. 10 shows what happens if primary side 7B misses a request from secondary side 5B for a switch-on of primary element 26 (e.g., after the first and second timers associated with the secondary side expire).

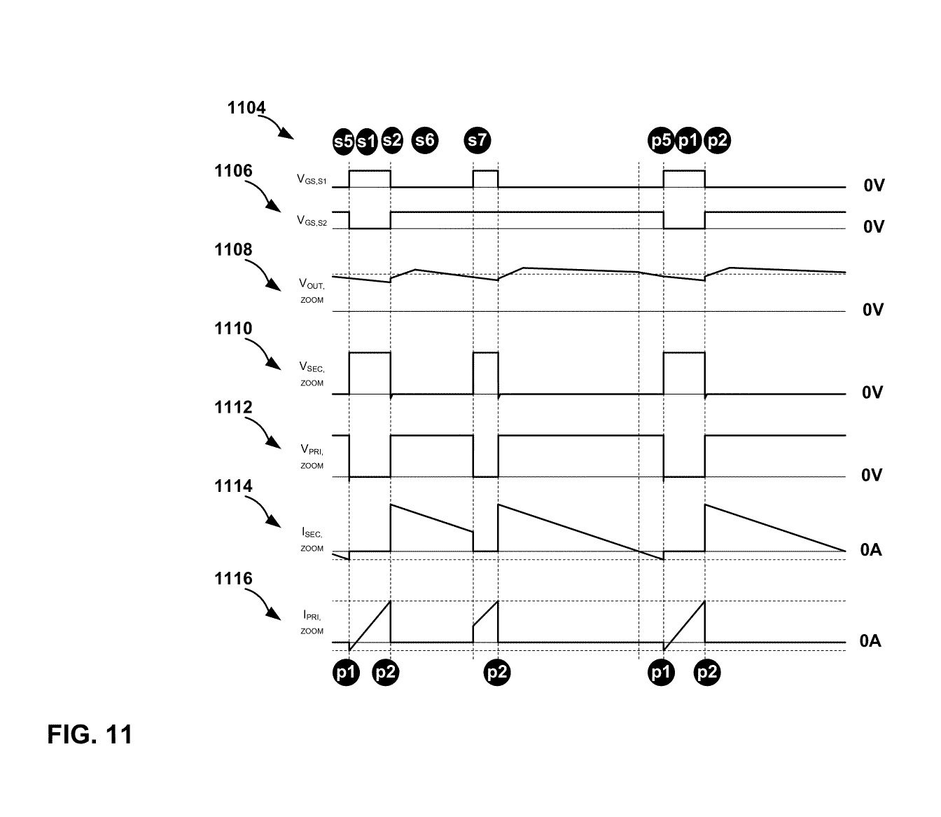

FIG. 11 is a timing diagram illustrating voltage and current characteristics of power converter 6B of FIG. 3 during an example operation of power converter 6B in which primary element 25 is switched-on while secondary side 5B is transferring energy from transformer 22 to the output capacitor 34B, in accordance with one or more aspects of the present disclosure. FIG. 11 shows plots 1104-1116 which each represent different voltage or current levels at various parts of power converter 6B. Plots 1104-1116 are not necessarily drawn to scale.

Plots 1104 and 1106 show the gate or driver signals (e.g., the voltage between the gate and source terminals) of elements 25 and 26, respectively. Plots 1112 and 1116 show the primary voltage and the primary current level at primary element 25 and plots 1110 and 1114 illustrate the secondary voltage and the secondary current levels at secondary element 26. Plot 1108 shows the output voltage (e.g., the voltage level at link 10 and across capacitor 34B) of converter 6B as the primary voltage and current levels at primary element 25 and the secondary voltage and current levels at secondary element 26 change over time.

FIG. 11 shows what happens if the primary element 25 is switched-on while the secondary element 26 on secondary side 5B of power converter 6B is still in an on-state. In some examples, to prevent the simultaneous switch-on of primary element 25 when secondary element 26 is switched on (e.g., due to erroneous negative current sensing at secondary side 5B), can be improved by comparing the primary voltage at primary element 25 (node 16C) with the supply voltage of the converter (node 16A) and only allow primary element to switch-on if the primary voltage is below or equal to the supply voltage of the converter. For example, state machine 44 may rely on the output from comparator 56 to determine whether the primary voltage is at or below the supply voltage of the converter. As shown in FIG. 11, one way to handle such a situation is to switch-off secondary element 26 prior to the secondary current transitioning below zero amps, such that a resynchronization of the primary and secondary sides can be performed either by expiring the third timer associated with primary side 7B or the second timer associated with secondary side 5B.

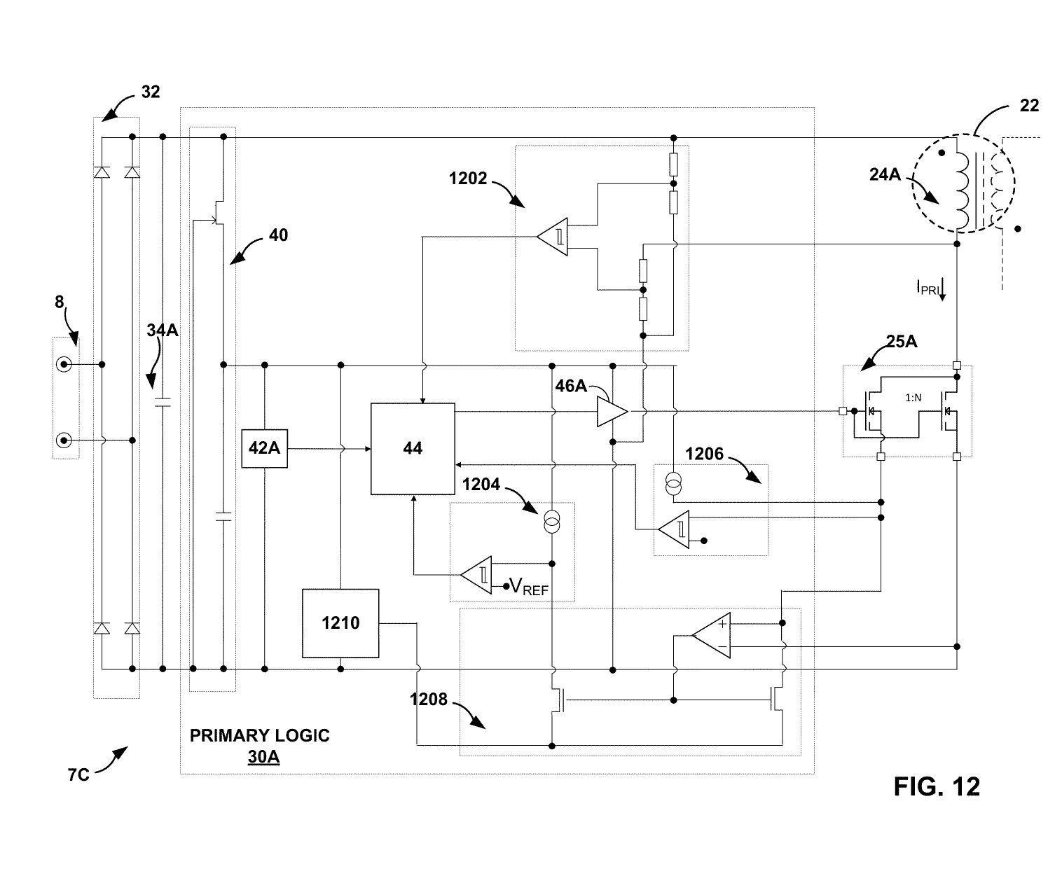

FIG. 12 is a conceptual diagram illustrating primary side 7C which represents a more detailed view of primary side 7B of power converter 6B shown in FIG. 3. FIG. 12 is described below within the context of power converter 6B of FIG. 3 and system 1 of FIG. 1.

In addition to components 32, 34A, 40, 42A, 44, 46A, and 24A, primary side 7C of FIG. 12 includes components 1202-1210. In addition, primary side 7C is shown having primary element 25A as an additional example of primary element 25. For example, primary element 25A is shown as being a high-voltage switch transistor with a matched sense cell.

Component 1202 makes up a primary comparator used by primary side 7C and state machine 44 to determine whether the voltage at primary element 25A is less than or equal to the supply voltage of the converter. Component 1204 represents a primary current comparator that state machine 44 may use to determine whether the primary current at primary element 25A is greater than, less than, or equal to a maximum current threshold.

Component 1206 represents a primary reverse current comparator that can detect the amount of current at primary element 25A even when primary element 25A is switched off. Component 1208 represents a primary single direction current replica generator that relies on a linear amplifier or comparator charging or discharging the current source gate voltage. Component 1210 represents a primary charge-pump negative voltage generation unit.

In some examples, power converter 6B may perform the primary current sensing at primary side 7C (e.g., using a shunt resistor or a Hall-sensor). In some examples, zero current detection and/or reverse current detection may be performed using a GMR element.

Component 1208 functions when primary element 25A is switched-on and the direction of the primary current at primary element 25A is positive (e.g., as indicated by the direction of the arrow in FIG. 12). Component 1208 may ensure that the source voltage potential of the power transistor and sense cell of primary element 25A are equal, and as such, may create a current replica that can be compared to a current reference to detect, by state machine 44, when to switch-off primary element 25A.

Component 1206 may function when primary element 25A is switched-off. If the primary voltage at primary element 25A is positive with reference to the source of the power transistor source, the sense sell source will be charged to a high potential by the current source of component 1206. If the primary voltage at primary element 25 becomes negative and a current starts to equally flow through the body/bulk-diode of the power transistor of primary element 25A, a current will start to flow through the body/bulk diode of the sense cell of primary element 25A and the input node of the comparator of component 1206 may be pulled low by this current and the comparator may trip. This may indicate that a negative current is flowing in primary side winding 24A. In response to the indication of the negative current, state machine 44 may determine to switch-on primary element 25A. Alternatively the change of the sense cell source voltage due to the capacitive coupling through the sense cell transistor of primary element 25A may be used to sense when the primary voltage at primary element 25A is falling, even before the current begins to flow through the body diode of primary element 25A.

The resistive divider input to the comparator of component 1202 may have a high cumulative resistance and a high division number. A drawback of such a component 1202 may cause the sensing to be slow unless a parallel capacitive divider is also used. Since the sensed voltages are typically high voltages, component 1202 may be too large or costly for some applications and therefore may be omitted in some examples. In lieu of component 1202, state machine 44 may perform operations as described above to prevent conflicts with secondary side 5B and the potential simultaneous switch-on of primary element 25A and the secondary element at secondary side 5B.

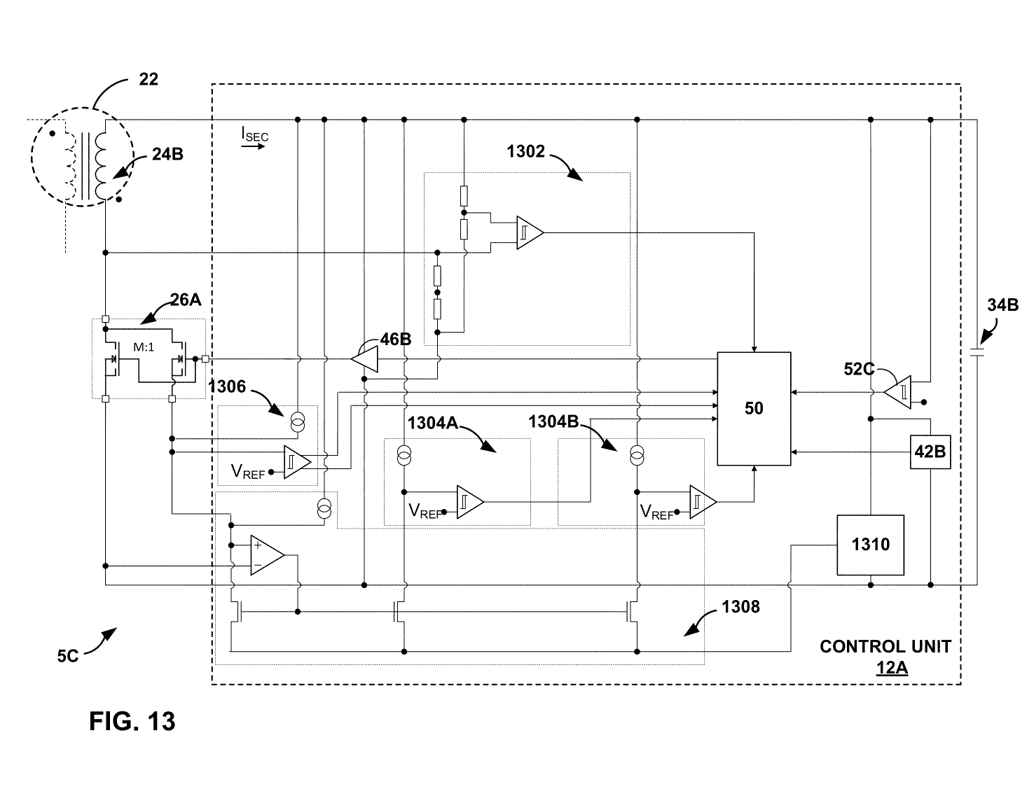

FIG. 13 is a conceptual diagram illustrating secondary side 5C which represents a more detailed view of secondary side 5B of power converter 6B shown in FIG. 3. FIG. 13 is described below within the context of power converter 6B of FIG. 3 and system 1 of FIG. 1.

In addition to components 34B, 42B, 52C. 46B, 50, and 24B, secondary side 5C of FIG. 13 includes components 1302-1310. In addition, secondary side 5C is shown having secondary element 26A as an additional example of secondary element 26. For example, secondary element 26A is shown as being a synchronous rectification switch transistor with a matched sense cell (i.e., a sense FET). The matched sense cell may have one or more transistor cells with matching characteristics to the transistor cells of the synchronous rectification switch transistor. The matched sense cell may be used by secondary side 5C to sense a level of current through the synchronous rectification switch transistor by instead, sense a matching level of current through the matched sense cell.

Component 1302 makes up a secondary comparator used by secondary side 5C and state machine 50 to determine whether secondary side 5B voltage at secondary element 26A is less than or equal to the output voltage across capacitor 34B. Component 1302 represents an optional component that may or may not be suited for similar reasons that component 1202 may not be suited, as is described above with respect to component 1202 of FIG. 12.

Component 1304A represents a secondary current comparator that state machine 50 may use to determine whether the secondary current at secondary element 26A is greater than, less than, or equal to a maximum negative current threshold. Component 1304B represents a secondary current comparator that state machine 50 may use to determine whether the secondary current at secondary element 26A is greater than, less than, or equal to a minimum current threshold when secondary element 26A is switched-on.

Component 1306 represents a secondary reverse current comparator that can detect the amount of current at secondary element 26A even when secondary element 26A is switched off. Component 1308 represents a secondary single direction current replica generator that relies on a linear amplifier or comparator charging or discharging the current source gate voltage. Component 1310 represents a secondary charge-pump negative voltage generation unit.

In some examples, power converter 6B may perform the secondary current sensing at secondary side 5C using a shunt resistor or a Hall-sensor. In some examples, zero current detection and/or reverse current detection may be performed using a GMR element.

Component 1308 functions when secondary element 26A is switched-on and the direction of the secondary current at secondary element 26A is either positive (direction of the arrow) or negative. Component 1308 may ensure that the source voltage potential of the power transistor and sense cell of secondary element 26A are equal, and as such, may create a current replica that can be compared to a current reference to detect when to switch-off secondary element 26A when the secondary current at secondary element 26A changes from a positive current to a negative current (e.g., when the output voltage is greater than or equal to a desired output voltage threshold), or detect when to switch-off secondary element 26A when the secondary current at secondary element 26A reaches a maximum current threshold when a negative current is being induced to signal to primary side 7B to switch-on primary element 26. Dual direction current sensing may be preferred for some applications. In the example of FIG. 12, dual direction current sensing is performed with the addition of an offset current provided by the current source of component 1308.

Component 1306 may function when secondary element 26A and the sense cell of secondary element 26A are switched-off. If the secondary voltage at secondary element 26A is positive with reference to the source of the power transistor source of secondary element 26A, the sense cell source of secondary element 26A will be charged to a high potential by the current source of component 1306. If the secondary voltage becomes negative and a current starts to equally flow through the body/bulk-diode of the power transistor of secondary element 26A, a current may start to flow through the body/bulk diode of the sense cell of secondary element 26A and the input node of the comparator of component 1306 may be pulled low and the comparator may trip. In this way, a single comparator can signal that both a positive current is flowing at the primary winding of transformer 22 and that the secondary voltage at secondary element 26A is negative, such that state machine 50 can determine whether to switch-on secondary element 26A. To determine when the secondary voltage at secondary element 26A is negative, state machine 50 may measure the secondary voltage. In some examples, the voltage at secondary element 26A may be determined using components that are integrated on a single integrated circuit since the output voltage and the secondary voltage may be relatively low voltages.

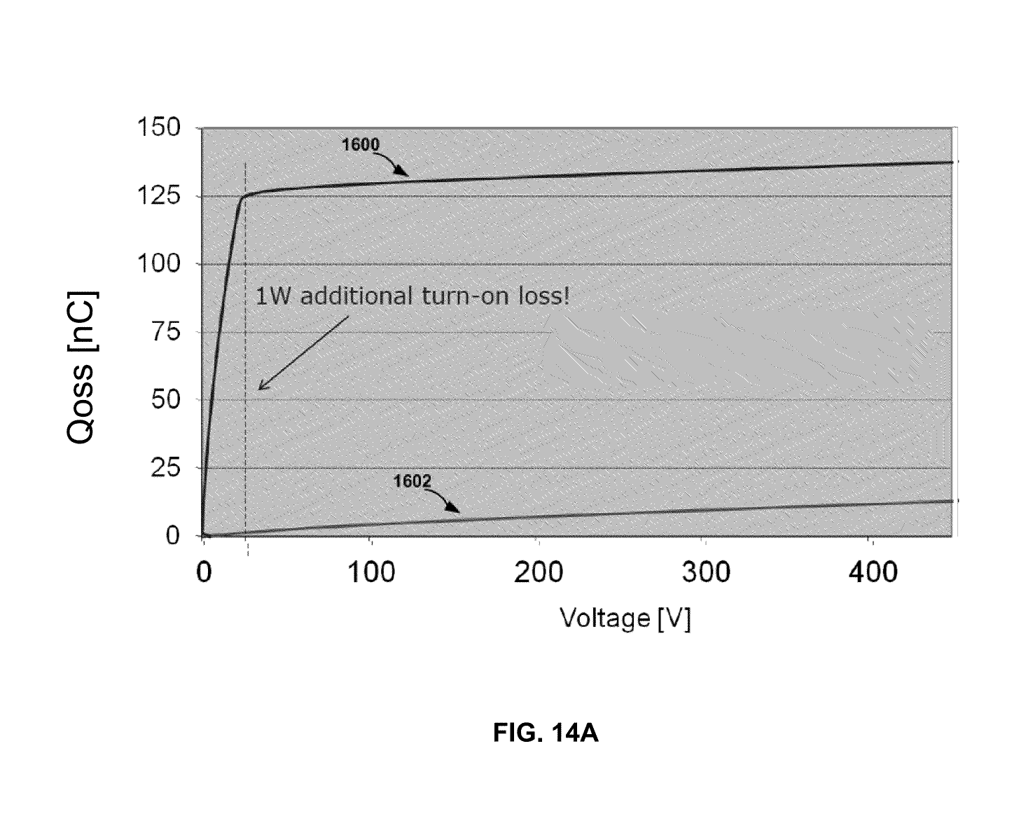

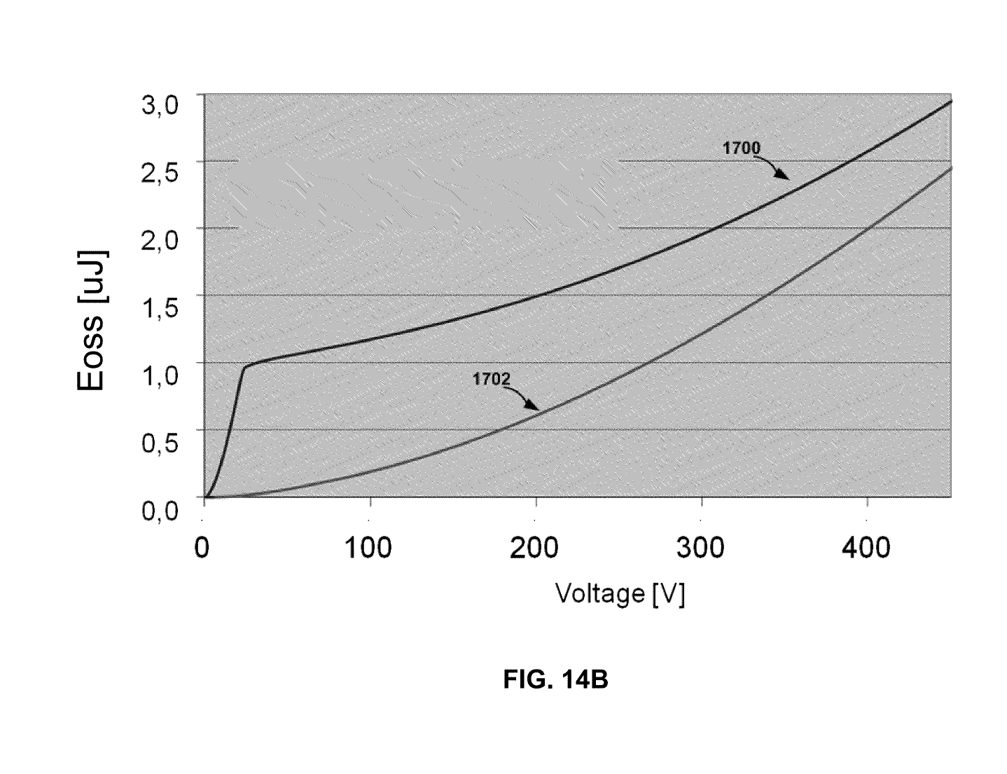

FIGS. 14A and 14B are diagrams illustrating characteristics, as a function of voltage, associated with either of the example power converters having a Gallium Nitride (GaN) based switch device as a primary element as opposed to a silicon based power MOSFET, in accordance with one or more aspects of the present disclosure, or a silicon based device as a primary element, more specifically a Superjunction element. FIGS. 14A and 14B are described in the context of FIGS. 2 and 3.

FIG. 14A is a diagram illustrating the charge stored in the output capacitance, as a function of voltage, associated with either of power converters 6A and 6B when a Gallium Nitride (GaN) based switch device is used as primary element 25 as opposed to a silicon based power MOSFET. For example, plot 1600 of FIG. 14A shows that the amount of charge drawn stored in the output capacitance of primary element 25 is greater when using a non-GaN based switch device is used as primary element 25. Plot 1602 of FIG. 14A shows the amount of charge stored in the output capacitance of primary element 25 is less when using a GaN based switch device as primary element 25.

FIG. 14B is a diagram illustrating energy stored in the output capacitance, as a function of voltage, associated with either of power converters 6A and 6B when a Gallium Nitride (GaN) based switch device is used as primary element 25, as opposed to a silicon based power MOSFET, in accordance with one or more aspects of the present disclosure. For example, plot 1700 of FIG. 14B shows the amount of energy stored in the output capacitance, of primary element 25 is higher when using a non-GaN based switch device is used as primary element 25. Plot 1702 of FIG. 14B shows the amount of energy stored in the, output capacitor of primary element 25 is less when using a GaN based switch device as primary element 25. As shown by FIG. 14B, less energy is lost when using a GaN based switch device as primary element 25 than when some other non-GaN based switch device is used.

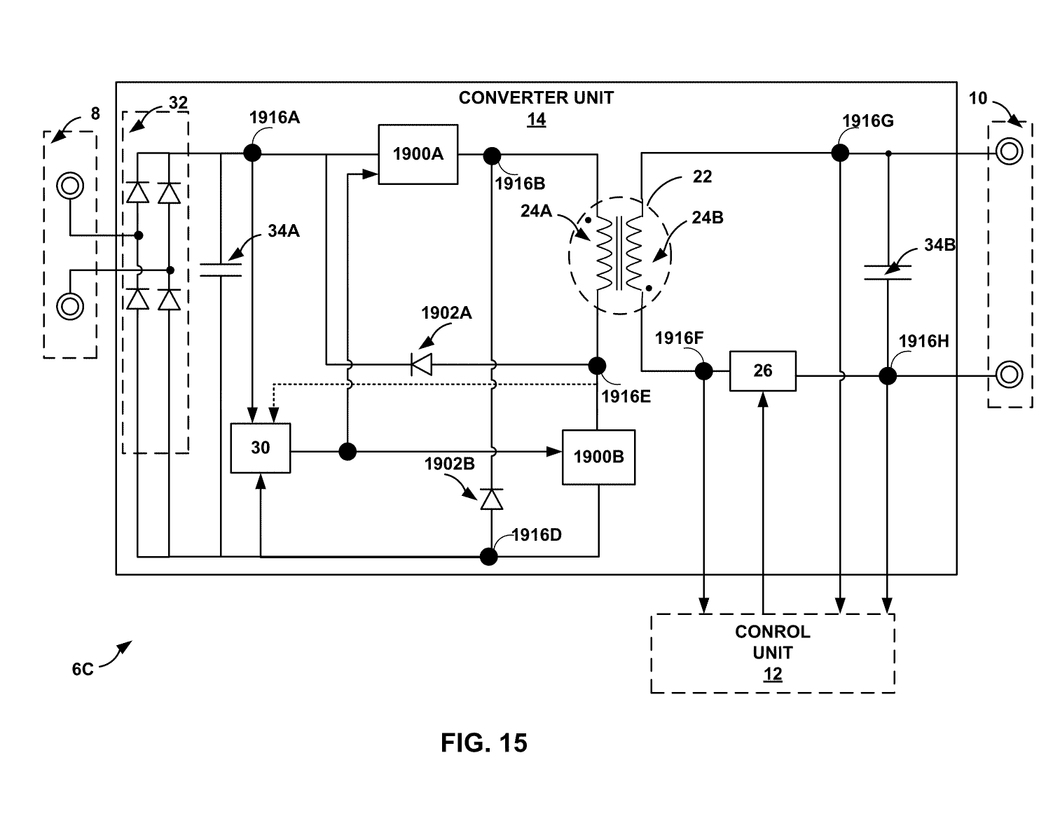

FIG. 15 is a conceptual diagram illustrating power converter 6C as an additional example of power converter 6 of system 1 shown in FIG. 1. Power converter 6C represents a “two-transistor flyback” converter and shares many of the same components as power converters 6A and 6B. Unlike converters 6A and 6B however, power converter 6C includes dual primary elements 1900A and 1900B and diodes 1902A and 1902B.

Transformer 22 of converter 6C is arranged to store energy between the primary side of power converter 6C and the secondary side of power converter 6C. Each of primary elements 1900A and 1900B is coupled to primary side winding 24A of transformer 22. Each of primary elements 1900A and 1900B is configured to switch-on or switch-off based on a primary voltage or a primary current at the primary side of power converter 6C. In other words, control logic 30 may sense the primary voltage or the primary current and cause primary elements 1900A and 1900B to switch-on to perform two-transistor flyback, power conversion techniques.

Power converter 6C also includes secondary element 26 coupled to secondary side winding 24B of transformer 22, and control unit 12 coupled to secondary element 26. Control unit 12 is isolated from both primary elements 1900A and 1900B. Control unit 12 is configured to control secondary element 26 consistent with synchronous rectification from secondary side 7C, as well as to control secondary element 26 to cause an energy transfer from the secondary side, via transformer 22, to the primary side as a way to signal to the primary side that the secondary side requires additional energy from source 2, and triggers primary logic 30 and primary elements 1900A and 1900B to perform dual-transistor, flyback conversion techniques.

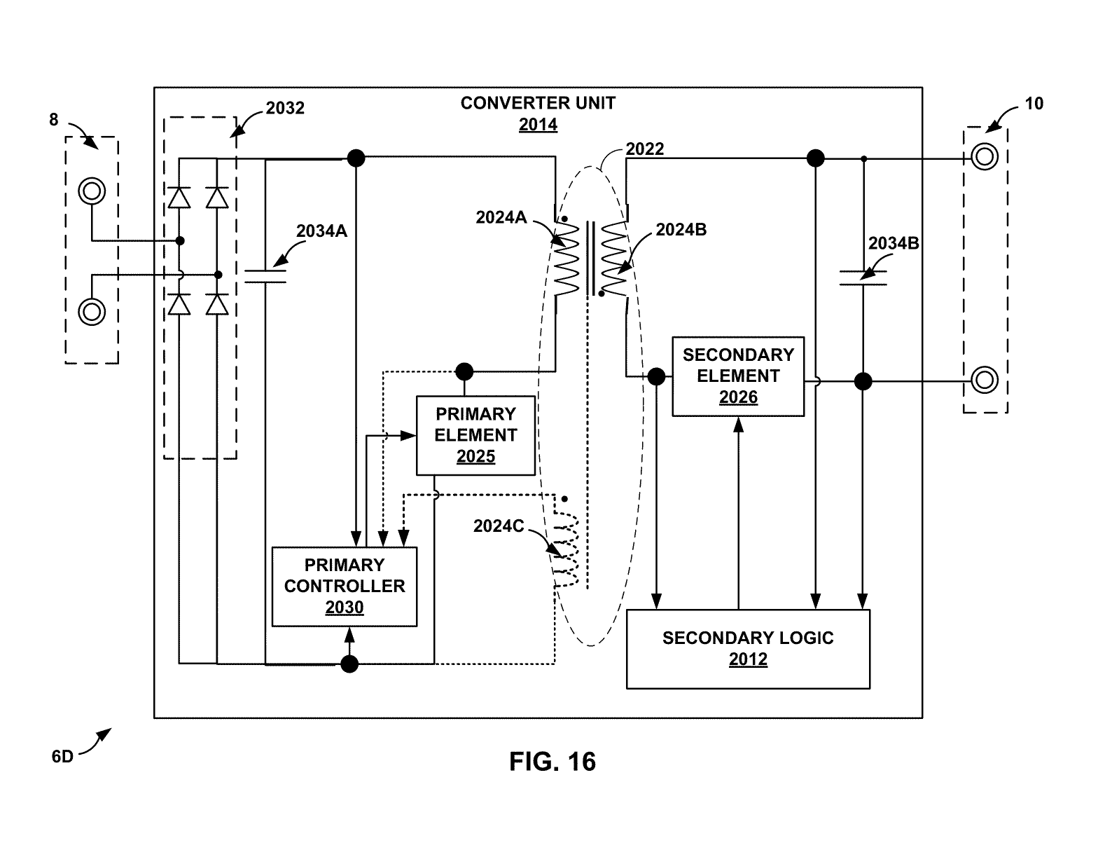

FIG. 16 is a conceptual diagram illustrating power converter 6D as an additional example of power converter 6 of system 1 shown in FIG. 1. Power converter 6D represents a flyback converter with primary side controller 2030 in communication with secondary logic 2012 via transformer 2022. Transformer 2022 of converter 6D is arranged primarily to temporarily store and then transfer energy between the primary side of power converter 6D and the secondary side of power converter 6D. Power converter 6D shares many of the same components as power converters 6A-6C. As is described below, unlike converters 6A-6C however, transformer 2022 of power converter 6D includes optional auxiliary winding 2024C, in addition to primary winding 2024A and secondary winding 2024B.

As described above with respect to transformer 22, each of the example converters described herein may need an auxiliary winding to supply primary logic 30 and/or control unit 12. For example, power consumption (e.g., by load 4) may be lower than in cases with full primary side control, but may still be too high to be supplied from power source 2 (e.g., an AC input) through a resistor.

Power converter 6D includes secondary element 2026 coupled to secondary side winding 2024B of transformer 2022, and secondary logic 2012 coupled to secondary element 26. Secondary logic 2012 is electrically isolated from primary elements 2025 and primary controller 2030. Secondary logic 2012 is configured to control secondary element 2026 consistent with synchronous rectification from the secondary side of power converter 6D, as well as to control secondary element 26 to cause an energy transfer from the secondary side of power converter 6D, via transformer 2022, to the primary side of power converter 6D as a way to signal to the primary side of power converter 6D that the secondary side of power converter 6D requires additional energy from source 2.

In some examples, the signal transferred via transformer 2022 from the secondary side, to the primary side of power converter 6D may trigger primary controller 2030 and primary element 2025 to perform flyback conversion techniques. In the signal transferred via transformer 2022 from the secondary side, to the primary side of power converter 6D may represent a transfer of other types of information. For example, the information received from the secondary side of power converter 6D indicate to primary controller 2030 when the output voltage level at link 10 has dropped below a required threshold. This change in output voltage may indicate to primary controller 30 that more energy needs to be transferred from the primary side of power converter 6D to the secondary side of power converter 6D for instance, when a load jump or other event occurs that may trigger power converter 6D to exit from a “stand-by mode” during which power converter 6D refrains from transferring energy to load 4 to an operational mode during which power converter 6D provides power to load 4.

Primary element 2025 is coupled to primary side winding 2024A of transformer 2022. Primary element 2025 is configured to switch-on or switch-off based on a primary voltage or a primary current associated with primary element 2025. For example, primary controller 2030 may sense a drain-source voltage (V_{DS}) associated with primary element 2025 and in response to determining that the voltage has fallen below a threshold (e.g., zero volts), provide a gate voltage that switches on primary element 2025 to perform flyback, power conversion techniques (e.g., begin transferring energy from primary winding 2024A to secondary winding 2024B). In addition or alternatively, primary controller 2030 may sense a current associated with primary element 2025 and in response to determining that the current has gone negative (e.g., less than zero amps), provide a gate voltage that switches on primary element 2025 to perform flyback, power conversion techniques (e.g., begin transferring energy from primary winding 2024A to secondary winding 2024B).

In some examples, primary controller 2030 may detect an energy transfer from the secondary side of power converter 6D by detecting a voltage at auxiliary winding 2024C rather than, or in addition to, detecting a change in voltage or current associated with primary element 2025 and/or primary winding 2024A. In other words, although auxiliary winding 2024C is optional, in some instances primary controller 2030 may rely on auxiliary winding 2024C to measure changes to primary side voltages as a way to determine whether to cause power converter 6D to “wake-up” and begin or resume transferring energy to load 4.

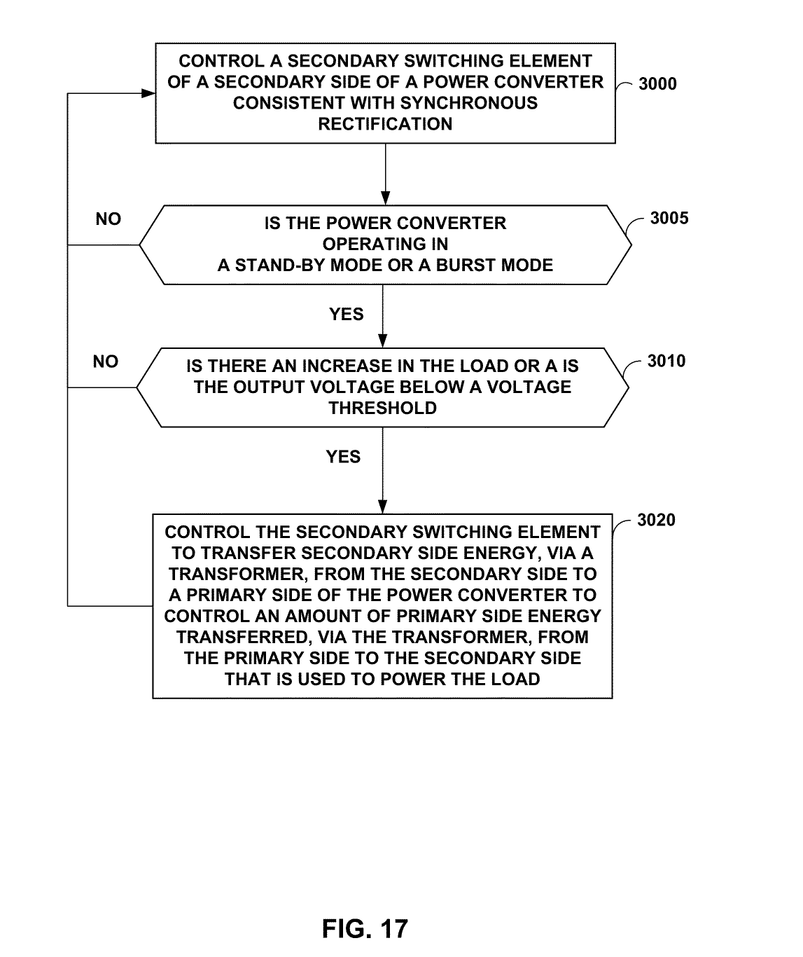

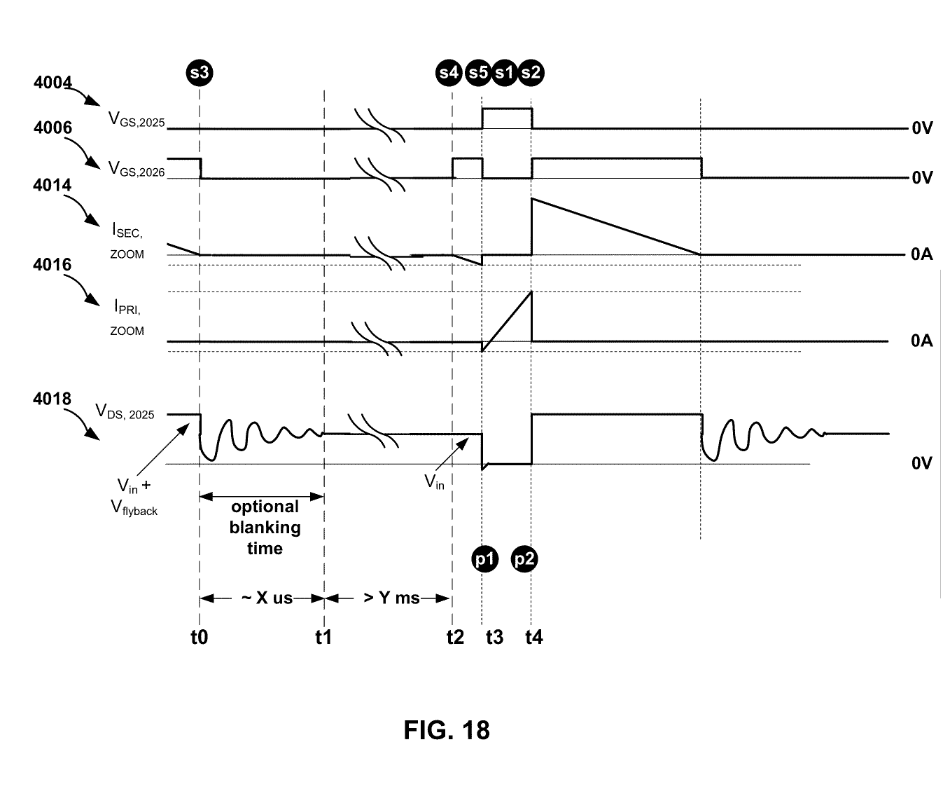

FIG. 17 is a flowchart illustrating example operations of the example power converter shown in FIG. 16, in accordance with one or more aspects of the present disclosure. For example, operations 3000-3020 may be performed by secondary logic 2012 of converter 6D. FIG. 18 is a timing diagram illustrating voltage and current characteristics of power converter 6D shown in FIG. 16, while converter 6D performs operations 3000-3020, in accordance with one or more aspects of the present disclosure. Plots 4004-4018 represent different voltage or current levels at various parts of power converter 6D during a steady state operation of power converter 6D. Plots 4004-4018 are not necessarily drawn to scale and share similarities to plots 604-616 of FIG. 6. Plots 4004 and 4006 show the gate or driver signals (e.g., the voltage between the gate and source terminals) of switching elements 2025 and 2026, plot 4016 shows the primary voltage at primary element 2025 and plots 4014 illustrates the secondary current levels at secondary element 2026. Plot 4018 shows the drain source voltage associated with primary element 2025.

Secondary logic 2012 may control secondary element 2026 consistent with synchronous rectification techniques (3000). FIG. 18 shows secondary logic 2012 performing a switch-on of secondary element 2026 at time t4. For example, to perform synchronous rectification, from the secondary side of converter 6D, secondary logic 2012 may determine the operating state of primary element 2025 based on the voltage and/or current at secondary side winding 2024B. Secondary logic 2012 may cause secondary element 2026 to operate in synch, and change operating states depending on the state of primary element 2025. Secondary logic 2012 may detect when primary element 2025 switches-off based on the voltage at secondary winding 2024B, and in response, cause secondary element 2026 to switch-on. Secondary logic 2012 may determine, based on the current at secondary side winding 2024B, when to cause secondary element 2026 to switch-off, before primary element 2025 switches back-on, such that the conduction periods of secondary element 2026 and primary element 2025 do not overlap.

When energy need not be transferred, power converter 6D may operate in a “stand-by” mode to consume little or no power. At times, power converter 6D may also operate in operate in “burst mode” to enable reflected voltage measurements to occur. Converter 6D may rely on a load jump, a drop in output voltage, or other triggering event to exit from “stand-by mode” or burst mode, during which power converter 6D refrains from transferring energy to load 4, to an operational mode during which power converter 6D provides power to load 4.

In response to determining that power converter 6D is operating in a stand-by mode or a burst mode (3005), secondary logic 2012 may determine whether there has been a change in load condition (e.g., from a stand-by mode or a burst mode condition) by determining whether there has been an increase in the load or whether the output voltage at the load has fallen below a voltage threshold (3010). If there has been an increase in the amount of load or the voltage has dropped below a voltage threshold while power converter 6D is operating in stand-by or burst mode, converter 6D may exit out of stand-by or burst mode and secondary logic 2012 may control secondary element 2026 to transfer secondary side energy, via transformer 22, from secondary side winding 2024B to a primary side winding 2024A of power converter 6D to control an amount of primary side energy transferred, via transformer 22, from primary side winding 2024A to secondary side winding 2024B that is used to power load 4 (3020).

In other words, secondary logic 2012 may determine whether a load (e.g., load 4) coupled to the secondary side of power converter 6D has exited from a stand-by mode or burst mode condition (3010), sufficient enough to cause secondary logic 2012 to “wake-up” out of stand-by or burst mode. That is, has the exit from the stand-by mode or burst mode condition triggered secondary side logic 2012 to begin controlling secondary element 2026 to transfer secondary side energy, via transformer 2022, from the secondary side of power converter 6D to the primary side of power converter 6D to control an amount of primary side energy transferred, via transformer 2022, from the primary side to the secondary side that is used to power load 4. If the amount of load has not changed, secondary logic 2012 may resume controlling secondary element 2026 consistent with synchronous rectification techniques (3000) and/or operating in stand-by or burst mode.

For example, secondary logic 2012 may detect “load jumps” or sudden changes in the amount of load or sudden changes in the output voltage at link 10 such as a jump to full load condition from a standby-mode to determine when to notify primary controller 2030 that it is time for primary controller 2030 to cause more primary side energy to be transferred via transformer 22 to power load 4. FIG. 18 shows that at time t0, primary controller may have caused primary element 2025 to stop transferring primary energy to the secondary side of converter 62. After a period of blanking time (e.g., on the order of microseconds) at time t1, secondary logic 2012 may begin detecting the secondary side voltage and current to discern whether more energy is needed to power load 4 (e.g., which has recently been connected to link 10 or may have merely depleted the primary side energy previously transferred). The blanking time may be needed on the primary side to differentiate between voltage drops coming from an oscillation of output capacitance (e.g., of primary element 2025) and leakage inductance of transformer 2022 and “real” voltage drops created by secondary logic 2012 and the transfer of energy from the secondary side to the primary side caused by secondary logic 2012.

FIG. 18 shows that at time t2, after a period of milliseconds, seconds, hours, days, or any other amount of time has elapsed, secondary logic 2012 may detect a change to the amount of load at link 10. Secondary logic 2012 may detect the change for example, in response to determining the secondary side current dropped below a current threshold (e.g., zero volts) and/or if the output voltage drops below a voltage threshold.

FIG. 18 shows that at time t3, secondary logic 2012 uses secondary element 2026 as an “active element” and pulses secondary element 2026 until time t3. This pulsing of secondary element 2026 may be inconsistent with normal synchronous rectification techniques, however, the pulsing may directly cause primary controller 2030 to resume power conversion operations. Said differently, secondary logic 2012 may pulse secondary element 2026 as a way to transfer secondary side energy, via transformer 2022, to the primary side of converter 6D so as to signal to primary controller 2030 that load 4 needs primary energy from source 2.

In this way, some of the techniques of this disclosure may enable a flyback converter to exit “deep sleep modes” where the primary side controller consumes a minimal amount of power for milliseconds, seconds, hours, days, or other long durations of time during a “no load” or light load condition, rather than periodically pulsing a primary element or relying on an opto-coupler signal as a way to determine when the load condition has changed. During these long time intervals, the converter according to some of these techniques may monitor the output voltage on the secondary side (e.g., periodically intervals). In case of a drop of output voltage, secondary side logic may “activate” a secondary-side synchronous rectification switching element to transfer secondary side energy from the secondary side, via the transformer, towards the primary side. This transfer of energy may cause either a voltage drop on the primary side switching element or even a reverse current through the primary side switching element. A primary side voltage drop or reverse current may be detected by the primary controller and interpreted as being a signal that was sent from the secondary side to transfer energy from the primary side by switching-on the primary side switching element.

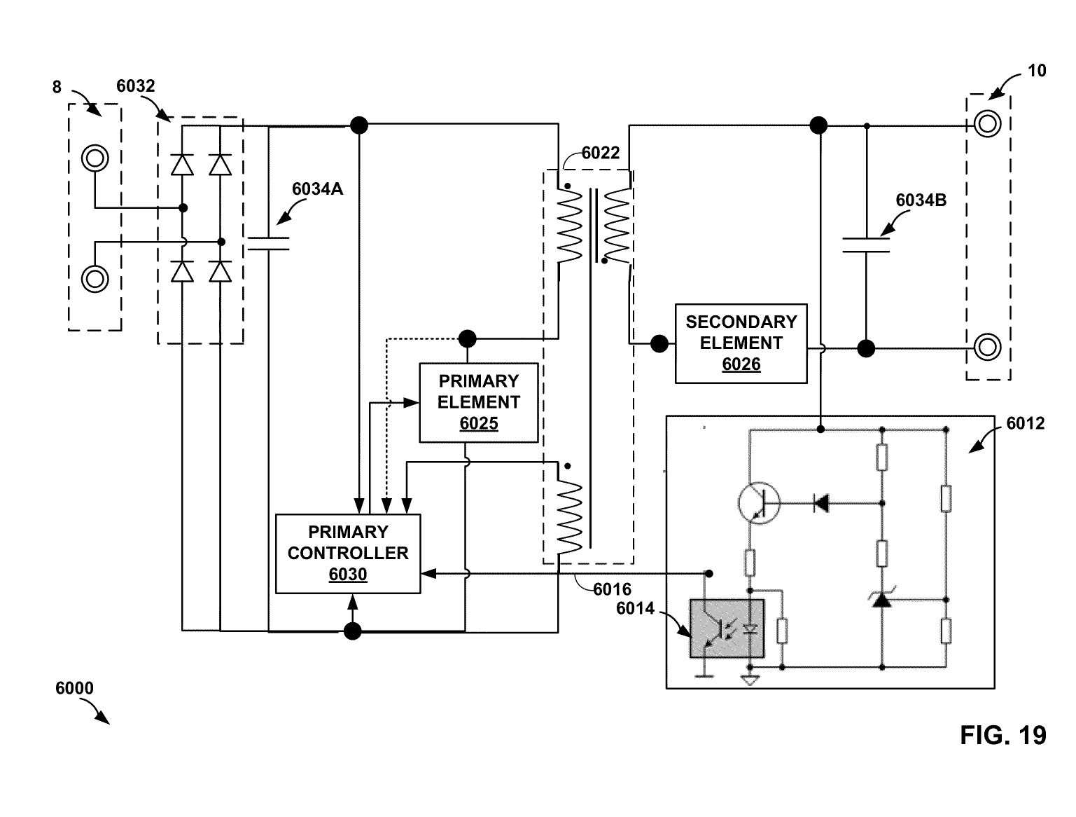

FIG. 19 is a conceptual diagram illustrating conventional power converter 6000 that, unlike power converter 6 shown in FIG. 1, relies on a separate electrically isolated transmission channel 6016 linking the primary and secondary sides of conventional power converter 6000. In other words, power converter 6000 represents a less desirable, more costly alternative way to provide information (e.g., feedback) from the secondary side of converter 6000 to the primary side of converter 6000. Converter 6000 relies on secondary logic 6012 which includes optocoupler 6014. For example, in the event of a load jump detected at link 10, secondary logic 6012 relies on optocoupler 6014 to signal, via transmission channel 6016, to primary controller 6030 to re-start operations on the primary side of converter 6000 and begin transferring energy via transformer 6022 to load 4. Converter 6000 is more expensive and requires more components than converters 6.

In some examples, converter 6000 may merely rely on the reflected voltage at the auxiliary winding of transformer 6022 as a way to determine when to begin or re-start operations on the primary side. For example, primary controller 6030 may measure the reflected voltage and if the reflected voltage falls below a threshold, may resume operations on the primary side. However, in order to cause the reflected voltage to accurately reflect the output voltage at link 10, primary controller 6030 may cycle primary element 6025 for at least one switching cycle. Typically a power converter such as converter 6000 may operate in “burst mode” to enable reflected voltage measurements to occur. Burst mode operation mandates however relatively short intervals to be sure that in case of a load jump, the output voltage at link 10 stays within its voltage limits. Relatively high burst mode activity consumes additional power and may conflict with a system's low-energy requirements during no-load and light load conditions.

Clause 1. A power circuit comprising: a transformer comprising a primary winding and a secondary winding; a primary side coupled to the primary winding, wherein the primary side includes a primary element configured to switch-on or switch-off based on a primary voltage or a primary current at the primary side; and a secondary side coupled to the secondary winding, wherein the secondary side includes a secondary element and a control unit that is isolated from the primary side, wherein the control unit is configured to control the secondary element to transfer secondary side energy, via the transformer, from the secondary side to the primary side to control an amount of primary side energy transferred, via the transformer, from the primary side to the secondary side.

Clause 2. The power circuit of clause 1, wherein the control unit is further configured to refrain from transferring the secondary side energy by switching off the secondary element when a secondary side current at the secondary side is less than or equal to a current threshold and an output voltage at the secondary side is greater than or equal to a voltage threshold.

Clause 3. The power circuit of any of clauses 1-2, wherein the control unit is further configured to transfer the secondary side energy by refraining from switching off the secondary element when a secondary side current at the secondary side is less than or equal to a current threshold and an output voltage at the secondary side is less than or equal to a voltage threshold.

Clause 4. The power circuit of any of clauses 1-3, wherein the control unit is further configured transfer the secondary side energy by switching on the secondary element when a secondary side current at the secondary side is less than or equal to a current threshold and an output voltage at the secondary side is less than or equal to a voltage threshold.

Clause 5. The power circuit of any of clauses 1-4, wherein the control unit is further configured to complete transferring the secondary side energy by switching off the secondary element when a secondary side current at the secondary side reaches a maximum negative current threshold.

Clause 6. The power circuit of any of clauses 1-5, wherein the control unit is further configured to complete transferring the secondary side energy by switching off the secondary element after a threshold amount of time that is consistent with when a secondary side current at the secondary side will reach a maximum negative current threshold.

Clause 7. The power circuit of any of clauses 1-6, wherein the control unit is further configured to switch on the secondary element, consistent with synchronous rectification, after the primary element switches off.

Clause 8. The power circuit of clause 7, wherein the control unit is further configured to switch on the secondary element in response to determining that a secondary current at the secondary element is greater than or equal to a current threshold and a secondary voltage at the secondary element is less than or equal to a voltage threshold.

Clause 9. The power circuit of any of clauses 1-8, wherein the power circuit is a flyback power converter.

Clause 10. The power circuit of any of clauses 1-9, wherein the secondary side energy is of a sufficient amount to indicate to the primary side that the primary element should be switched-on or switched-off.

Clause 11. The power circuit of any of clauses 1-10, wherein the primary winding and the secondary winding of the transformer are configured for transferring the primary side energy, via the transformer, from the primary side to the secondary side to power a load coupled to the secondary side.

Clause 12. A power circuit comprising: a transformer comprising a primary winding and a secondary winding; a secondary side coupled to the secondary winding; and a primary side coupled to the primary winding, wherein the primary side includes a primary element and primary logic, the primary logic being configured to control the primary element by at least detecting, at the primary side, secondary side energy being transferred from the secondary side, via the transformer, to the primary side.

Clause 13. The power circuit of clause 12, wherein the primary logic is configured to detect the secondary side energy by detecting at least one of a primary voltage at the primary side that satisfies a voltage threshold or a primary current at the primary side that satisfies a current threshold.

Clause 14. The power circuit of clause 13, wherein the primary voltage corresponds to a voltage across the primary element.

Clause 15. The power circuit of any of clauses 13-14, wherein the primary current is a current exiting the primary winding.

Clause 16. The power circuit of any of clauses 12-15, wherein the primary logic is further configured to switch off the primary element after an amount of time elapses since the primary element last switched on.

Clause 17. The power circuit of any of clauses 12-16, wherein the primary logic is further configured to control the primary element based at least in part on an amount of the secondary side energy being transferred.

Clause 18. A method comprising: controlling, by a control unit positioned at a secondary side of a power converter, a secondary element of the secondary side consistent with synchronous rectification, wherein the secondary element is coupled to a secondary winding of a transformer of the power converter; and controlling, by the control unit, the secondary element to transfer secondary side energy, via the transformer, from the secondary side to a primary side of the power converter to control an amount of primary side energy transferred, via the transformer, from the primary side to the secondary side.

Clause 19. The method of clause 18, wherein controlling the secondary element to transfer the secondary side energy comprises: determining, by the control unit, an output voltage at the secondary side of the power converter; and responsive to determining that the output voltage does not satisfy a voltage threshold, controlling, by the control unit, the secondary element to transfer the secondary side energy, via the transformer, from the secondary side to the primary side to control the amount of primary side energy transferred, via the transformer, from the primary side to the secondary side.

Clause 20. The method of any of clauses 18-19, wherein controlling the secondary element to transfer the secondary side energy comprises: refraining from switching off, by the control unit, the secondary element when a secondary side current at the secondary side is less than or equal to a current threshold and an output voltage at the secondary side is less than or equal to the voltage threshold.

Clause 21. The method of any of clauses 18-20, wherein controlling the secondary element to transfer the secondary side energy comprises: switching on, by the control unit, the secondary element when a secondary side current at the secondary side is less than or equal to a current threshold and an output voltage at the secondary side is less than or equal to the voltage threshold.

Clause 22. The method of any of clauses 18-21, wherein the control unit is electrically isolated from the primary side of the power converter.

Clause 23. The method of any of clauses 18-22, further comprising: responsive to determining that an output voltage at the secondary side does satisfy a voltage threshold: controlling, by the control unit, the secondary element to refrain from transferring the at the secondary side energy from the secondary side, via the transformer, to the primary side; and controlling, by the control unit, consistent with synchronous rectification, the secondary element to operate in synch with a primary element at the primary side.

Clause 24. The method of any of clauses 18-23, wherein the power converter is a flyback type power converter.

Clause 25. A method comprising: detecting, by control logic positioned at a primary side of a power converter, secondary side energy being transferred from a secondary side of the power converter, via a transformer of the power converter, to the primary side; and responsive to detecting the secondary side energy, switching on, by the control logic, the primary element.

Clause 26. The method of any of clause 25, wherein detecting the secondary side energy further comprises detecting at least one of a primary voltage at the primary side that satisfies a voltage threshold or a primary current at the primary side that satisfies a current threshold.

Clause 27. The method of any of clauses 25-26, wherein the power converter is a flyback type power converter.

Clause 28. A computer readable storage medium comprising instructions that, when executed, configure at least one processor of a power converter device to perform any of the methods of clauses 18-27.

Clause 29. The power circuit of clause 1 comprising means for performing any of the methods of clauses 18-24.

Clause 30. The power circuit of clause 12 comprising means for performing any of the methods of clauses 25-26.

Clause 31. A power circuit comprising: a transformer comprising a primary winding and a secondary winding; a primary side coupled to the primary winding, wherein the primary side includes a primary element configured to switch-on or switch-off based at least in part on a primary voltage or a primary current at the primary side; and a secondary side coupled to the secondary winding, wherein the secondary side includes a secondary element and secondary logic that is isolated from the primary side, wherein the secondary logic is configured to: detect a change to an amount of load coupled to the power circuit; and in response to detecting the change to the amount of load, control the secondary element to transfer secondary side energy, via the transformer, from the secondary side to the primary side to control an amount of primary side energy transferred, via the transformer, from the primary side to the secondary side.

Clause 32. The power circuit of clause 31, wherein the secondary logic is further configured to detect the change to the amount of load in response to determining that a secondary side current at the secondary side is less than or equal to a current threshold.

Clause 33. The power circuit of any of clauses 31-32, wherein the secondary logic is further configured to detect the change to the amount of load in response to determining that an output voltage at the secondary side is less than or equal to a voltage threshold.

Clause 34. The power circuit of any of clauses 31-33, wherein the secondary logic is further configured to detect the change to the amount of load after a threshold amount of time has elapsed during which the power circuit refrained from transferring primary side energy, via the transformer, from the primary side to the secondary side.

Clause 35. The power circuit of clause 34, wherein the threshold amount of time is at least one millisecond.

Clause 36. The power circuit of any of clauses 34-35, wherein the threshold amount of time is at least one second.

Clause 37. The power circuit of any of clauses 34-36, wherein the threshold amount of time is at least greater than a blanking time associated with the primary element.

Clause 38. The power circuit of any of clauses 31-37, wherein the secondary logic is further configured to refrain from transferring the secondary side energy by switching off the secondary element when a secondary side current at the secondary side is less than or equal to a current threshold and an output voltage at the secondary side is greater than or equal to a voltage threshold.

Clause 39. The power circuit of any of clauses 31-38, wherein the secondary logic is further configured to transfer the secondary side energy by: while the secondary element is initially switched on, subsequently refraining from switching off the secondary element when a secondary side current at the secondary side is less than or equal to a current threshold and an output voltage at the secondary side is less than or equal to a voltage threshold.

Clause 40. The power circuit of any of clauses 31-39, wherein the secondary logic is further configured to transfer the secondary side energy by: while the secondary element is initially switched off, subsequently switching on the secondary element when a secondary side current at the secondary side is less than or equal to a current threshold and an output voltage at the secondary side is less than or equal to a voltage threshold.

Clause 41. The power circuit of any of clauses 31-40, wherein the secondary logic is further configured to complete transferring the secondary side energy by switching off the secondary element when a secondary side current at the secondary side reaches a maximum negative current threshold.

Clause 42. The power circuit of any of clauses 31-41, wherein the secondary logic is further configured to complete transferring the secondary side energy by switching off the secondary element after a threshold amount of time that is consistent with when a secondary side current at the secondary side will reach a maximum negative current threshold.

Clause 43. The power circuit of any of clauses 31-42, wherein the secondary logic is further configured to switch on the secondary element, consistent with synchronous rectification, after the primary element switches off.

Clause 44. The power circuit of clause 43, wherein the secondary logic is further configured to switch on the secondary element in response to determining that a secondary current at the secondary element is greater than or equal to a current threshold and a secondary voltage at the secondary element is less than or equal to a voltage threshold.

Clause 45. The power circuit of any of clauses 31-44, wherein the power circuit is a flyback power converter.

Clause 46. The power circuit of any of clauses 31-45, wherein the secondary side energy is of a sufficient amount to indicate to the primary side that the primary element should be switched-on or switched-off.

Clause 47. The power circuit of any of clauses 31-46, wherein the primary winding and the secondary winding of the transformer are configured for transferring the primary side energy, via the transformer, from the primary side to the secondary side to power a load coupled to the secondary side.

Clause 48. A power circuit comprising: a transformer comprising a primary winding and a secondary winding; a secondary side coupled to the secondary winding; and a primary side coupled to the primary winding, wherein the primary side includes a primary element and a primary controller configured to control the primary element by at least detecting, at the primary side, secondary side energy being transferred from the secondary side, via the transformer, to the primary side in response to the secondary side detecting a change to an amount of load coupled to the secondary side.

Clause 49. The power circuit of clause 48, wherein the primary controller is further configured to detect the secondary side energy being transferred from the secondary side, via the transformer, after a threshold amount of time has elapsed during which the power circuit refrained from transferring primary side energy, via the transformer, from the primary side to the secondary side.

Clause 50. The power circuit of clause 49, wherein the threshold amount of time is at least one millisecond.

Clause 51. The power circuit of any of clauses 49-50, wherein the threshold amount of time is at least one second.

Clause 52. The power circuit of any of clauses 49-51, wherein the threshold amount of time is at least greater than a blanking time associated with the primary element.

Clause 53. The power circuit of any of clauses 48-52, wherein the primary controller is configured to detect the secondary side energy by detecting at least one of a primary voltage at the primary side that satisfies a voltage threshold or a primary current at the primary side that satisfies a current threshold.

Clause 54. The power circuit of clause 53, wherein the primary controller corresponds to a voltage across the primary element.

Clause 55. The power circuit of any of clauses 53-54, wherein the primary current is a current exiting the primary winding.

Clause 56. The power circuit of any of clauses 48-55, wherein the primary controller is further configured to switch off the primary element after an amount of time elapses since the primary element last switched on.

Clause 57. The power circuit of any of clauses 48-56, wherein the primary controller is further configured to control the primary element based at least in part on an amount of the secondary side energy being transferred.

Clause 58. The power circuit of any of clauses 48-57, wherein the primary winding is a first primary winding, the transformer comprises a second primary winding, and the primary voltage corresponds to a voltage across the second primary winding.

Clause 59. The power circuit of clause 58, wherein the primary current is a current exiting the second primary winding.

Clause 60. A method comprising: controlling, by a control unit positioned at a secondary side of a power converter, a secondary element of the secondary side consistent with synchronous rectification, wherein the secondary element is coupled to a secondary winding of a transformer of the power converter; detecting, by the control unit, a change to an amount of load coupled to the secondary side of the power converter; and responsive to detecting the change to the amount of load, controlling, by the control unit, the secondary element to transfer secondary side energy, via the transformer, from the secondary side to a primary side of the power converter to control an amount of primary side energy transferred, via the transformer, from the primary side to the secondary side.

Clause 61. A method comprising: detecting, by a control unit positioned at a primary side of a power converter, secondary side energy being transferred from a secondary side of the power converter, via a transformer of the power converter, to the primary side in response to a change to an amount of load coupled to the secondary side; and responsive to detecting the secondary side energy, switching on, by the control unit, the primary element.

Clause 62. A computer readable storage medium comprising instructions that, when executed, configure at least one processor of a power converter device to perform any of the methods of clauses 60-61.

Clause 63. The power circuit of clause 31 comprising means for performing the method of clause 60.

Clause 64. The power circuit of clause 48 comprising means for performing the method of clause 61.

Clause 65. The power circuit of clause 31 comprising means for performing any of the methods of clauses 18-24 and 60.

Clause 66. The power circuit of clause 48 comprising means for performing any of the methods of clauses 25-26 and 61.

Clause 67. The power circuit of clause 1 comprising means for performing any of the methods of clauses 18-24 and 60.

Clause 368. The power circuit of clause 12 comprising means for performing any of the methods of clauses 25-26 and 61.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. Many of the described examples concern techniques for communicating between the secondary and primary side of a flyback converter so as to enable the use of a common controller for both sides of the flyback converter. However, the described techniques for communicating between two sides of a transformer may also be used for other reasons, or in other transformer applications. These and other examples are within the scope of the following claims.

What is claimed is:

1. A power circuit comprising:
a transformer comprising a primary winding and a secondary winding;
a primary side coupled to the primary winding, wherein the primary side includes a primary element configured to switch-on or switch-off based on a primary voltage or a primary current at the primary side; and
a secondary side coupled to the secondary winding, wherein the secondary side includes a secondary element and a control unit that is isolated from the primary side, wherein the control unit is configured to control the secondary element to transfer secondary side energy, via the transformer, from the secondary side to the primary side to control an amount of primary side energy transferred, via the transformer, from the primary side to the secondary side.

2. The power circuit of claim 1, wherein the control unit is further configured to refrain from transferring the secondary side energy by switching off the secondary element when a secondary side current at the secondary side is less than or equal to a current threshold and an output voltage at the secondary side is greater than or equal to a voltage threshold.

3. The power circuit of claim 1, wherein the control unit is further configured to transfer the secondary side energy by refraining from switching off the secondary element when a secondary side current at the secondary side is less than or equal to a current threshold and an output voltage at the secondary side is less than or equal to a voltage threshold.

4. The power circuit of claim 1, wherein the control unit is further configured transfer the secondary side energy by switching on the secondary element when a secondary side current at the secondary side is less than or equal to a current threshold and an output voltage at the secondary side is less than or equal to a voltage threshold.

5. The power circuit of claim 1, wherein the control unit is further configured to complete transferring the secondary side energy by switching off the secondary element when a secondary side current at the secondary side reaches a maximum negative current threshold.

6. The power circuit of claim 1, wherein the control unit is further configured to complete transferring the secondary side energy by switching off the secondary element after a threshold amount of time that is consistent with when a secondary side current at the secondary side will reach a maximum negative current threshold.

7. The power circuit of claim 1, wherein the control unit is further configured to switch on the secondary element, consistent with synchronous rectification, after the primary element switches off.

8. The power circuit of claim 7, wherein the control unit is further configured to switch on the secondary element in response to determining that a secondary current at the secondary element is greater than or equal to a current threshold and a secondary voltage at the secondary element is less than or equal to a voltage threshold.

9. The power circuit of claim 1, wherein the power circuit is a flyback power converter.

10. The power circuit of claim 1, wherein the secondary side energy is of a sufficient amount to indicate to the primary side that the primary element should be switched-on or switched-off.

11. The power circuit of claim 1, wherein the primary winding and the secondary winding of the transformer are configured for transferring the primary side energy, via the transformer, from the primary side to the secondary side to power a load coupled to the secondary side.

12. A power circuit comprising:
a transformer comprising a primary winding and a secondary winding;
a secondary side coupled to the secondary winding; and
a primary side coupled to the primary winding, wherein the primary side includes a primary element and primary logic, the primary logic being configured to control the primary element by at least detecting, at the primary side, secondary side energy being transferred from the secondary side, via the transformer, to the primary side.

13. The power circuit of claim 12, wherein the primary logic is configured to detect the secondary side energy by detecting at least one of a primary voltage at the primary side that satisfies a voltage threshold or a primary current at the primary side that satisfies a current threshold.

14. The power circuit of claim 13, wherein the primary voltage corresponds to a voltage across the primary element.

15. The power circuit of claim 13, wherein the primary current is a current exiting the primary winding.

16. The power circuit of claim 12, wherein the primary logic is further configured to switch off the primary element after an amount of time elapses since the primary element last switched on.

17. The power circuit of claim 12, wherein the primary logic is further configured to control the primary element based at least in part on an amount of the secondary side energy being transferred.

18. A method comprising:
controlling, by a control unit positioned at a secondary side of a power converter, a secondary element of the secondary side consistent with synchronous rectification, wherein the secondary element is coupled to a secondary winding of a transformer of the power converter; and
controlling, by the control unit, the secondary element to transfer secondary side energy, via the transformer, from the secondary side to a primary side of the power converter to control an amount of primary side energy transferred, via the transformer, from the primary side to the secondary side.

19. The method of claim 18, wherein controlling the secondary element to transfer the secondary side energy comprises:
determining, by the control unit, an output voltage at the secondary side of the power converter; and
responsive to determining that the output voltage does not satisfy a voltage threshold, controlling, by the control unit, the secondary element to transfer the secondary side energy, via the transformer, from the secondary side to the primary side to control the amount of primary side energy transferred, via the transformer, from the primary side to the secondary side.

20. The method of claim 18, wherein controlling the secondary element to transfer the secondary side energy comprises:
refraining from switching off, by the control unit, the secondary element when a secondary side current at the secondary side is less than or equal to a current threshold and an output voltage at the secondary side is less than or equal to the voltage threshold.

21. The method of claim 18, wherein controlling the secondary element to transfer the secondary side energy comprises:
switching on, by the control unit, the secondary element when a secondary side current at the secondary side is less than or equal to a current threshold and an output voltage at the secondary side is less than or equal to the voltage threshold.

22. The method of claim 18, wherein the control unit is electrically isolated from the primary side of the power converter.

23. The method of claim 18, further comprising:
responsive to determining that an output voltage at the secondary side does satisfy a voltage threshold:
controlling, by the control unit, the secondary element to refrain from transferring the at the secondary side energy from the secondary side, via the transformer, to the primary side; and
controlling, by the control unit, consistent with synchronous rectification, the secondary element to operate in synch with a primary element at the primary side.

24. The method of claim 18, wherein the power converter is a flyback type power converter.

25. A method comprising:
detecting, by control logic positioned at a primary side of a power converter, secondary side energy being transferred from a secondary side of the power converter, via a transformer of the power converter, to the primary side; and
responsive to detecting the secondary side energy, switching on, by the control logic, the primary element.

26. The method of claim 25, wherein detecting the secondary side energy further comprises detecting at least one of a primary voltage at the primary side that satisfies a voltage threshold or a primary current at the primary side that satisfies a current threshold.

27. The method of claim 25, wherein the power converter is a flyback type power converter.
